(19) United States
(12) Patent Application Publication
(10) Pub. No.: US 2023/0168538 A1
(43) Pub. Date: Jun. 1, 2023

(54) OPTICAL ELEMENT AND LIGHT GUIDE ELEMENT

(71) Applicant: FUJIFILM Corporation, Tokyo (JP)

(72) Inventors: Yukito SAITOH, Minamiashigara-shi (JP); Akiko WATANO, Minamiashigara-shi (JP); Fumitake MITOBE, Minamiashigara-shi (JP); Hiroshi SATO, Minamiashigara-shi (JP); Katsumi SASATA, Minamiashigara-shi (JP)

(73) Assignee: FUJIFILM Corporation, Tokyo (JP)

(21) Appl. No.: 18/159,824

(22) Filed: Jan. 26, 2023

Related U.S. Application Data
(63) Continuation of application No. PCT/JP2021/023281, filed on Jun. 21, 2021.

(30) Foreign Application Priority Data
Jul. 31, 2020 (JP) 2020-130177

(51) Int. Cl. G02F 1/1335

(52) U.S. Cl. CPC G02F 1/133543; G02F 1/133524; G02F 1/133536

(57) ABSTRACT

An optical element comprising: a cholesteric liquid crystal layer obtained by cholesteric alignment of a liquid crystal compound, in which the cholesteric liquid crystal layer has a liquid crystal alignment pattern in which a direction of an optical axis derived from the liquid crystal compound changes while continuously rotating in at least one in-plane direction, a helical pitch of a helical axis direction in the cholesteric alignment gradually changes in a thickness direction of the cholesteric liquid crystal layer, and the cholesteric liquid crystal layer has a peak of reflection at each of a first wavelength λ and a second wavelength λ/2.

### CROSS-REFERENCE TO RELATED APPLICATIONS

This application is a Continuation of PCT International Application No. PCT/JP2021/023281 filed on Jun. 21, 2021, which claims priority under 35 U.S.C §119(a) to Japanese Patent Application No. 2020-130177 filed on Jul. 31, 2020. Each of the above application(s) is hereby expressly incorporated by reference, in its entirety, into the present application.

### BACKGROUND OF THE INVENTION

### 1. Field of the Invention

The present invention relates to an optical element that diffracts incident light and a light guide element including the optical element.

### 2. Description of the Related Art

As the optical element, the use of a cholesteric liquid crystal layer obtained by cholesteric alignment of a liquid crystal compound is disclosed.

For example, WO2016/194961A discloses a reflective structure comprising: a plurality of helical structures each extending in a predetermined direction; a first incident surface that intersects the predetermined direction and into which light is incident; and a reflecting surface that intersects the predetermined direction and reflects the light incident from the first incident surface, in which the first incident surface includes one of end parts in each of the plurality of helical structures, each of the plurality of helical structures includes a plurality of structural units that lies in the predetermined direction, each of the plurality of structural units includes a plurality of elements that are helically turned and laminated, each of the plurality of structural units includes a first end part and a second end part, the second end part of one structural unit among structural units adjacent to each other in the predetermined direction forms the first end part of the other structural unit, alignment directions of the elements positioned in the plurality of first end parts included in the plurality of helical structures are aligned, the reflecting surface includes at least one first end part included in each of the plurality of helical structures, and the reflecting surface is not parallel to the first incident surface.

WO2016/194961A describes a helical structure obtained by cholesteric alignment of a liquid crystal compound. In addition, a reflective structure described in WO2016/194961A diffracts and reflects incident light instead of specularly reflecting incident light.

In addition, JP2005-513241A describes a biaxial film having a cholesteric structure and a deformed helix with an elliptical refractive index ellipsoid, the biaxial film reflecting light having a wavelength of shorter than 380 nm.

### SUMMARY OF THE INVENTION

Incidentally, recently, augmented reality (AR) glasses that display a virtual image and various information or the like to be superimposed on a scene that is actually being seen have been put into practice. The AR glasses are also called, for example, smart glasses or a head-mounted display (HMD).

In the AR glasses, for example, an image displayed by a display (optical engine) is incident into one end of a light guide plate, propagates in the light guide plate, and is emitted from another end of the light guide plate such that the virtual image is displayed to be superimposed on a scene that a user is actually seeing.

In the AR glasses, for example, light that carries and supports an image displayed by the display is diffracted using a diffraction element to be incident into the light guide plate at an angle where total reflection can occur. In addition, in the AR glasses, the light that is totally reflected and propagates in the light guide plate is also diffracted by the diffraction element such that the light is emitted from the light guide plate to an observation portion by a user.

As is well known, the cholesteric liquid crystal layer obtained by cholesteric alignment of a liquid crystal compound has wavelength-selective reflectivity where light in a specific wavelength range is selectively reflected. In addition, the reflective structure described in WO2016/194961A includes the cholesteric liquid crystal layer and can diffract and reflect incident light.

Therefore, by using the cholesteric liquid crystal layer described in WO2016/194961A, for example, as an incidence element (diffraction element on the incidence side) of the AR glasses, an image having a desired color can be incident into the light guide plate such that the light is totally reflected and propagates in the light guide plate.

However, as described above, the cholesteric liquid crystal layer selectively reflects only light in a predetermined wavelength range.

Accordingly, in order to cause light components in discontinuous different wavelength ranges to be incident into one light guide plate, a plurality of cholesteric liquid crystal layers are necessary.

In addition, in the diffraction element, in a case where wavelengths of light components to be diffracted are different, angles of diffraction are also different. In general, in the diffraction element, as the wavelength of light to be diffracted increases, the diffraction angle increases. Therefore, only with the configuration where the number of cholesteric liquid crystal layers increases, it is difficult to cause light components in different wavelength ranges to be appropriately incident into one light guide plate such that the light is totally reflected in the light guide plate.

In addition, as is well known, in a case where light is incident into the cholesteric liquid crystal layer from an direction oblique to a normal line of a main surface (maximum surface), so-called blue shift in which a selective reflection wavelength range is shifted to a shorter wavelength side occurs.

On the other hand, light emitted from the display or the like is incident into the incidence element at various angles.

Therefore, in the diffraction element including the cholesteric liquid crystal layer that is known in the art, it is difficult to cause light in a predetermined wavelength range to be incident into the light guide plate at an angle where total reflection can occur depending on the entire surface of an image display surface of the display. As a result, the diffraction element including the cholesteric liquid crystal layer has a problem in that the so-called field of view (FOV) is narrowed in the AR glasses used for the incidence side of the light guide plate.

An object of the present invention is to solve the above-described problem of the related art and to provide: an optical element that has a sufficient width of reflection wavelength range for a wavelength range including λ and a wavelength range including λ/2 and where, for example, for use as the above-described incidence element of the light guide plate, light components in discontinuous different wavelength ranges can be incident into a light guide plate at an angle where total reflection can occur depending on the entire surface of a display screen of a display; and a light guide element including the optical element.

In order to achieve the object, the present invention has the following configurations.

[1] An optical element comprising:
   a cholesteric liquid crystal layer obtained by cholesteric alignment of a liquid crystal compound,
   in which the cholesteric liquid crystal layer has a liquid crystal alignment pattern in which a direction of an optical axis derived from the liquid crystal compound changes while continuously rotating in at least one in-plane direction,
   a helical pitch of a helical axis direction in the cholesteric alignment gradually changes in a thickness direction of the cholesteric liquid crystal layer, and
   the cholesteric liquid crystal layer has a peak of reflection at each of a first wavelength λ and a second wavelength λ/2.
[2] The optical element according to [1],
   in which the cholesteric liquid crystal layer has regions where diffraction efficiencies of light having the second wavelength λ/2 are different in a plane.
[3] A light guide element comprising:
   the optical element according to [1] or [2]; and
   a light guide plate.
[4] The light guide element according to [3],
   in which the optical element is an incidence element that causes light having the first wavelength λ and light having the second wavelength λ/2 to be incident to the light guide plate at an angle where the light is totally reflected.
[5] The light guide element according to [3], further comprising:
   an incidence element that causes light to be incident to the light guide plate; and
   an emission element that emits light from the light guide plate,
   in which the optical element is an emission element that causes light having the second wavelength λ/2 to be emitted from the light guide plate, and
   the cholesteric liquid crystal layer has regions where diffraction efficiencies of the light having the second wavelength λ/2 are different in a plane.
[6] The light guide element according to [5],
   in which in the cholesteric liquid crystal layer, a diffraction efficiency of light having the second wavelength λ/2 gradually increases in a direction away from the incidence element.

According to the present invention, it is possible to provide: an optical element that has a sufficient width of reflection wavelength range for a wavelength range including λ and a wavelength range including λ/2 and where two light components in different wavelength ranges can be diffracted in the same direction; and a light guide element including the optical element.

### BRIEF DESCRIPTION OF THE DRAWINGS

FIG. 1 is a diagram conceptually showing an example of an image display apparatus including a light guide element according to the present invention.

FIG. 2 is a diagram conceptually showing an example of a cholesteric liquid crystal layer of an optical element according to the present invention.

FIG. 3 is a conceptual diagram in a case where a part of a liquid crystal compound of the cholesteric liquid crystal layer shown in FIG. 2 is seen from a helical axis direction.

FIG. 4 is a diagram conceptually showing an incidence element of the light guide element shown in FIG. 1.

FIG. 5 is a plan view showing the cholesteric liquid crystal layer of the incidence element shown in FIG. 4.

FIG. 6 is a conceptual diagram showing one example of an exposure device that exposes an alignment film of the incidence element shown in FIG. 4.

FIG. 7 is a diagram conceptually showing a scanning electron microscope image of a cross-section of the cholesteric liquid crystal layer of the optical element according to the present invention.

FIG. 8 is a conceptual diagram showing an action of the cholesteric liquid crystal layer of the optical element according to the present invention.

FIG. 9 is a diagram in a case where a part of a plurality of liquid crystal compounds that are twisted and aligned along a helical axis is seen from the helical axis direction.

FIG. 10 is a diagram conceptually showing an existence probability of the liquid crystal compound seen from the helical axis direction in the optical element according to the present invention.

FIG. 11 is a graph conceptually showing an example of reflection characteristics of the cholesteric liquid crystal layer of the optical element according to the present invention.

FIG. 12 is a diagram conceptually showing an example of a cholesteric liquid crystal layer in the related art.

FIG. 13 is a diagram in a case where a part of a liquid crystal compound of the cholesteric liquid crystal layer in the related art shown in FIG. 12 is seen from a helical axis direction.

FIG. 14 is a diagram conceptually showing an existence probability of the liquid crystal compound seen from the helical axis direction in the cholesteric liquid crystal layer in the related art.

FIG. 15 is a diagram conceptually showing another example of the arrangement of the liquid crystal compounds in the cholesteric liquid crystal layer.

FIG. 16 is a conceptual diagram showing the incidence element of the image display apparatus shown in FIG. 1.

FIG. 17 is a diagram conceptually showing an example of an image display apparatus including another example of the light guide element according to the present invention.

### DESCRIPTION OF THE PREFERRED EMBODIMENTS

Hereinafter, an optical element and a light guide element according to an embodiment of the present invention will be described in detail based on a preferred embodiment shown in the accompanying drawings.

In the present specification, numerical ranges represented by “to” include numerical values before and after “to” as lower limit values and upper limit values.

In the present specification, “(meth)acrylate” represents “either or both of acrylate and methacrylate”.

In the present specification, the meaning of “the same” and “equal” includes a case where an error range is generally allowable in the technical field.

In the present specification, visible light refers to light having a wavelength which can be observed by human eyes among electromagnetic waves and refers to light in a wavelength range of 380 to 780 nm. Invisible light refers to light in a wavelength range of shorter than 380 nm or longer than 780 nm.

In addition, although not limited thereto, in visible light, light in a wavelength range of 420 to 490 nm refers to blue light, light in a wavelength range of 495 to 570 nm refers to green light, and light in a wavelength range of 620 to 750 nm refers to red light.

In the present specification, a selective reflection center wavelength refers to an average value of two wavelengths at which, in a case where a minimum value of a transmittance of a target object (member) is represented by Tmin (%), a half value transmittance: T½ (%) represented by the following expression is exhibited.

Expression for obtaining Half Value Transmittance: T½ = 100 - (100 - Tmin) ÷ 2

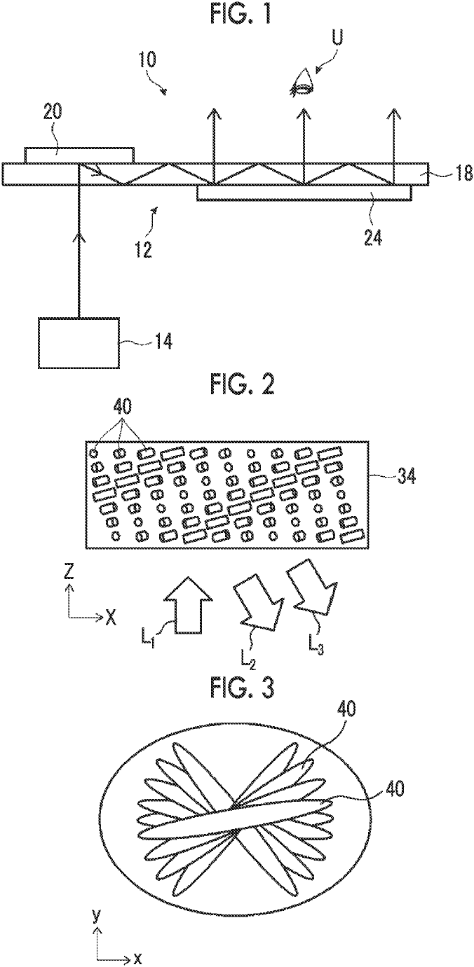

FIG. 1 is a diagram conceptually showing an example of an image display apparatus including a light guide element according to an embodiment of the present invention.

An image display apparatus 10 shown in FIG. 1 is used for, for example, the above-described AR glasses and includes a light guide element 12 according to the embodiment of the present invention and a display 14.

The light guide element 12 includes a light guide plate 18, an incidence element 20, and an emission element 24. Both of the incidence element 20 and the emission element 24 are reflective diffraction elements, and the incidence element 20 is the optical element according to the embodiment of the present invention.

In the light guide element in the example shown in the drawing, the light guide plate 18 is an elongated rectangular plate-shaped material, the incidence element 20 is provided on a main surface in the vicinity of one end part in a longitudinal direction, and the emission element 24 is provided on a main surface in the vicinity of another end part in the longitudinal direction.

The light guide element according to the embodiment of the present invention is not limited to this configuration, and various configurations of a light guide element that is used for well-known AR glasses and includes a light guide plate, an incidence element (incidence portion), and an emission element (emission portion).

As one example, a configuration can be used where a rectangular light guide plate is provided, a rectangular incidence element is provided in the vicinity of a corner portion of one main surface of the light guide plate, and an emission element is provided on another main surface of the light guide plate to cover the entire surface of a region other than the incidence element in a plane direction. As another example, a configuration can be used where a rectangular light guide plate is provided, a rectangular incidence element is provided in the vicinity of an end part of one main surface of the light guide plate and at the center of one side, and an emission element is provided on another main surface of the light guide plate to cover the entire surface of a region other than the incidence element in a plane direction.

The main surface is the maximum surface of a sheet-shaped material (for example, a plate-shaped material, a film, or a layer). In addition, the plane direction is a plane direction (in-plane direction) of the main surface.

As shown in FIG. 1, in the image display apparatus 10 shown in the example shown in the drawing, light that carries and supports an image displayed (emitted)by the display 14 is diffracted and reflected by the incidence element 20 to be incident into the light guide plate 18 at an angle where total reflection can occur.

The light incident into the light guide plate 18 propagates in the light guide plate 18 while repeating total reflection and is incident into the emission element 24. The emission element 24 diffracts and reflects the incident light to emit the light from the light guide plate 18 to an observation position by the user U.

In the image display apparatus 10, the display 14 is not particularly limited. For example, various well-known displays used in AR glasses or the like can be used.

Examples of the display include a liquid crystal display, an organic electroluminescent display, and a scanning type display employing a digital light processing (DLP) type projector or Micro Electro Mechanical Systems (MEMS) mirror. Examples of the liquid crystal display include a liquid crystal on silicon (LCOS).

The display 14 may display a color image or may display a monochrome image. The image display apparatus including the light guide element according to the embodiment of the present invention may include a plurality of displays that display monochrome images having different colors.

In the image display apparatus including the light guide element according to the embodiment of the present invention, optionally, a well-known projection lens used in AR glasses or the like may be provided between the display 14 and a position of the light guide plate 18 where the incidence element 20 is disposed.

Here, in the image display apparatus 10, light to be emitted from the display 14 is not limited and may be unpolarized light (natural light), linearly polarized light, or circularly polarized light.

Optionally, depending on the polarization of light to be emitted from the display, a circular polarization plate consisting of a linear polarizer and a λ/4 plate, a λ/4 plate, or the like may be provided between the display 14 and the light guide plate 18.

In the image display apparatus 10 in the example shown in the drawing, the light guide element 12 includes the light guide plate 18, the incidence element 20, and the emission element 24.

The light guide plate 18 is a well-known light guide plate that reflects light incident thereinto and propagates (guides) the reflected light. In the example shown in the drawing, the light guide plate 18 has an elongated rectangular planar shape.

As the light guide plate 18, various well-known light guide plates used for a backlight unit or the like of AR glasses or a liquid crystal display can be used without any particular limitation.

The refractive index of the light guide plate 18 is not particularly limited and is preferably high. Specifically, the refractive index of the light guide plate 18 is preferably 1.7 to 2.0 and more preferably 1.8 to 2.0. By adjusting the refractive index of the light guide plate 18 to be 1.7 to 2.0, an angle range where light can be totally reflected and propagate in the light guide plate 18 can be widened.

As shown in FIG. 1, in the image display apparatus 10 shown in the example shown in the drawing, light that carries and supports an image displayed (emitted) by the display 14 is diffracted and reflected by the incidence element 20 to be incident into the light guide plate 18 at an angle where total reflection can occur.

In the image display apparatus 10 in the example shown in the drawing, the incidence element 20 is the optical element according to the embodiment of the present invention.

The optical element (incidence element 20) according to the embodiment of the present invention includes a cholesteric liquid crystal layer obtained by cholesteric alignment of a liquid crystal compound. In other words, the cholesteric liquid crystal layer is obtained by immobilizing a cholesteric liquid crystalline phase.

In the optical element according to the embodiment of the present invention, the cholesteric liquid crystal layer has a liquid crystal alignment pattern in which a direction of an optical axis derived from a liquid crystal compound changes while continuously rotating in at least one in-plane direction.

By having the above-described liquid crystal alignment pattern, the cholesteric liquid crystal layer can diffract and reflect light having a selective reflection wavelength. In this case, in a case where a length over which the direction of the optical axis derived from the liquid crystal compound in the liquid crystal alignment pattern rotates by 180° in a plane is set as a single period (hereinafter also referred to as the single period of the liquid crystal alignment pattern), the diffraction angle depends on the length of the single period and the helical pitch of the helical structure. Therefore, the diffraction angle can be adjusted by adjusting the single period of the liquid crystal alignment pattern. In the present specification, “°” represents “degree”.

In addition, the cholesteric liquid crystal layer has a pitch gradient structure in which a helical pitch of a helical axis direction in the cholesteric alignment gradually changes in a thickness direction of the cholesteric liquid crystal layer. In the following description, the pitch gradient structure will also be referred to as the PG structure.

Further, in the optical element according to the embodiment of the present invention, the cholesteric liquid crystal layer has a peak of reflection at each of a first wavelength λ and a second wavelength λ/2.

Although described below, as conceptually shown in FIG. 3, the cholesteric liquid crystal layer of the optical element according to the embodiment of the present invention has a configuration in which, in a case where the arrangement of liquid crystal compounds is seen from the helical axis direction of the cholesteric liquid crystalline phase, an angle between molecular axes of the adj acent liquid crystal compounds 40 gradually changes. In other words, in a case where the arrangement of the liquid crystal compounds 40 is seen from the helical axis direction, the existence probability of the liquid crystal compounds 40 varies.

In the following description, the configuration in which, in a case where the arrangement of liquid crystal compounds is seen from the helical axis direction of the cholesteric liquid crystalline phase, an angle between molecular axes of adjacent liquid crystal compounds gradually changes will also be referred to as the cholesteric liquid crystal layer having a refractive index ellipsoid. The cholesteric liquid crystalline phase having a refractive index ellipsoid has a peak of reflection at each of the first wavelength λ and the second wavelength λ/2.

The first wavelength λ that is the first peak wavelength of reflection is originally a wavelength corresponding to a selective reflection center wavelength in the cholesteric liquid crystal layer (cholesteric liquid crystalline phase) where the liquid crystal compound is cholesterically aligned. That is, the first wavelength λ is a wavelength of primary light (primary diffracted light) in the cholesteric liquid crystal layer that acts as a reflective diffraction element.

On the other hand, the second wavelength λ/2 that is the second peak wavelength of reflection is a wavelength that is half of the first wavelength λ. That is, the second wavelength λ is a wavelength of secondary light (secondary diffracted light) in the cholesteric liquid crystal layer that acts as a reflective diffraction element.

In the present invention, the central wavelength of the second wavelength λ/2 is not limited to the length that is completely half of the central wavelength of the first wavelength λ. Here, the first wavelength λ originally corresponds to the selective reflection center wavelength of the cholesteric liquid crystalline phase. In a case where the helical pitch of the cholesteric liquid crystalline phase in the thickness direction is fixed, Since the peak wavelength λ has not a fixed value but a given range, the corresponding second wavelength λ/2 also has a given range.

The central wavelength of the second wavelength λ/2 may be in a range of ½ ± 100 nm of the central wavelength of the first wavelength λ. For example, in a case where the central wavelength of the first wavelength λ is 1100 nm, the central wavelength of the second wavelength λ/2 may be in a range of 550 nm ± 100 nm.

FIG. 2 is a diagram conceptually showing an example of the cholesteric liquid crystal layer of the optical element (incidence element 20) according to the present invention.

The cholesteric liquid crystal layer 34 is a layer obtained by cholesteric alignment of the liquid crystal compound 40. In addition, in the present invention, the cholesteric liquid crystal layer 34 has a liquid crystal alignment pattern in which a direction of an optical axis derived from a liquid crystal compound changes while continuously rotating in at least one in-plane direction.

In the cholesteric liquid crystal layer 34, a molecular axis derived from the liquid crystal compound 40 is twisted and aligned along a helical axis. In the example shown in FIG. 2, the liquid crystal compound 40 is a rod-like liquid crystal compound, and a direction of the molecular axis derived from the liquid crystal compound matches with a longitudinal direction of the liquid crystal compound 40.

Further, although not shown in FIG. 2, in the present invention, the cholesteric liquid crystal layer 34 has the PG structure in which the helical axis of the cholesteric alignment gradually changes in the thickness direction. Therefore, the helical axis of the helical structure in the cholesteric alignment is tilted in the thickness direction (in FIG. 2, an up-down direction) of the cholesteric liquid crystal layer 34.

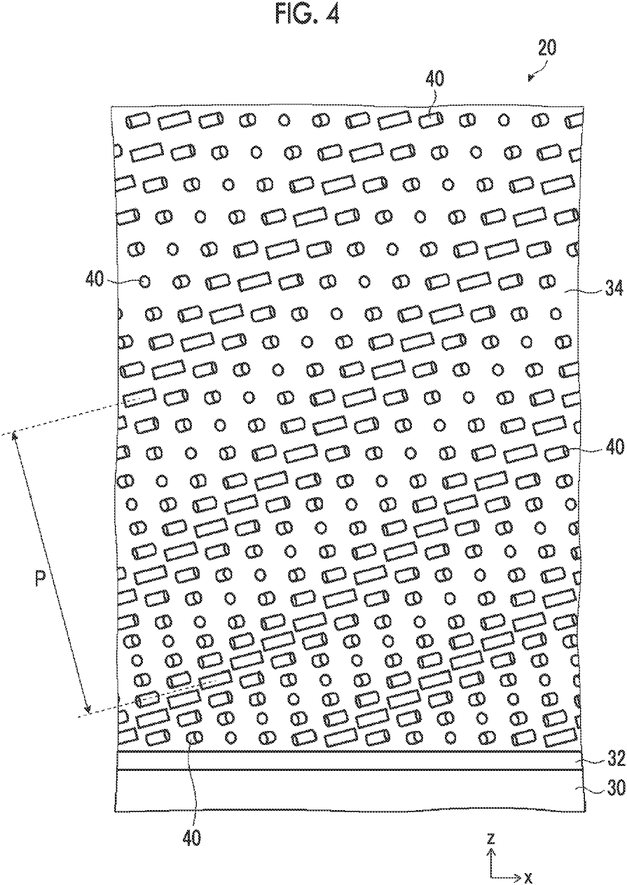

In the cholesteric liquid crystal layer 34, the helical axis is parallel to a direction perpendicular to bright portions and dark portions in a cross-section observed with a scanning electron microscope (SEM) described below. Accordingly, the direction of the helical axis of the helical structure in the cholesteric alignment gradually changes in the thickness direction of the cholesteric liquid crystal layer 34 (refer to FIG. 4).

In FIG. 2, the number of helices in the helical structure (cholesteric structure) in the thickness direction of the cholesteric liquid crystal layer 34 is half of a pitch. Actually, a helical structure corresponding to at least several pitches is provided.

In addition, as described above, the cholesteric liquid crystal layer 34 has the PG structure. Therefore, the helical pitch of the helical structure gradually changes in the thickness direction of the cholesteric liquid crystal layer 34. In the example in the drawing, for example, the helical pitch gradually increases upward in the drawing.

In the present invention, the PG structure of the cholesteric liquid crystal layer is not limited to this example. Conversely, the helical pitch may gradually decrease upward in the drawing.

In the following description, the thickness direction (the up-down direction in FIG. 1) of the optical element (cholesteric liquid crystal layer 34) is set as a z direction, and plane directions perpendicular to the thickness direction is set as a x direction (the left-right direction in FIG. 1) and a y direction (direction perpendicular to the paper plane in FIG. 1).

That is, FIG. 2 is a diagram showing a cross-section parallel to the z direction and the x direction.

An action of the cholesteric liquid crystal layer 34 (optical element) will be described below in detail.

FIG. 4 conceptually shows an example of a layer configuration of the incidence element 20, that is, the optical element according to the embodiment of the present invention.

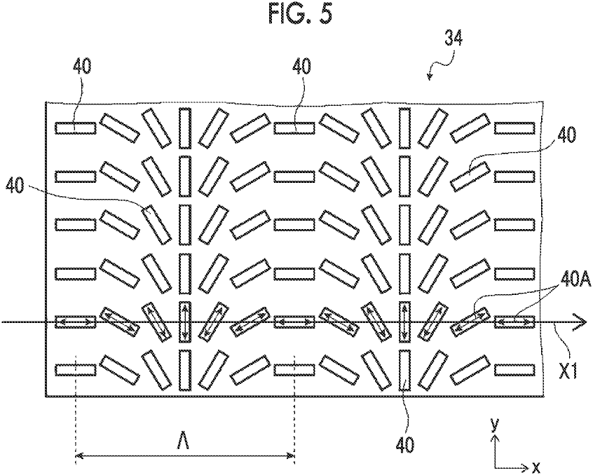

FIG. 5 conceptually shows the alignment state of the liquid crystal compound 40 in a plane of the main surface of the cholesteric liquid crystal layer 34.

As shown in FIG. 4, the incidence element 20 includes a support 30, an alignment film 32, and the cholesteric liquid crystal layer 34 that exhibits an action as a reflective diffraction element.

The layer configuration of the incidence element 20, that is, the optical element according to the embodiment of the present invention is not limited to the configuration shown in FIG. 4 including the support 30, the alignment film 32, and the cholesteric liquid crystal layer 34.

For example, the incidence element may consist of the alignment film 32 and the cholesteric liquid crystal layer 34 by peeling off the support 30 from the incidence element 20 shown in FIG. 4. Alternatively, the incidence element may consist of only the cholesteric liquid crystal layer 34 by peeling off the support 30 and the alignment film 32 from the incidence element 20 shown in FIG. 4. Alternatively, the incidence element may be an element where another support (substrate, base material) is bonded to the cholesteric liquid crystal layer 34 by peeling off the support 30 and the alignment film 32 from the incidence element 20 shown in FIG. 4.

### Support

The support 30 supports the alignment film 32 and the cholesteric liquid crystal layer 34.

As the support 30, various sheet-shaped materials (films or plate-shaped materials) can be used as long as they can support the alignment film 32 and the cholesteric liquid crystal layer 34.

A transmittance of the support 30 with respect to corresponding light is preferably 50% or higher, more preferably 70% or higher, and still more preferably 85% or higher.

The thickness of the support 30 is not particularly limited and may be appropriately set depending on the use of the optical element, a material for forming the support 30, and the like in a range where the alignment film 32 and the cholesteric liquid crystal layer 34 can be supported.

The thickness of the support 30 is preferably 1 to 1000 µm, more preferably 3 to 250 µm, and still more preferably 5 to 150 µm.

The support 30 may have a monolayer structure or a multi-layer structure.

In a case where the support 30 has a monolayer structure, examples thereof include supports formed of glass, triacetyl cellulose (TAC), polyethylene terephthalate (PET), polycarbonates, polyvinyl chloride, acryl, polyolefin, and the like. In a case where the support 30 has a multi-layer structure, examples thereof include a support including: one of the above-described supports having a monolayer structure that is provided as a substrate; and another layer that is provided on a surface of the substrate.

### Alignment Film

In the incidence element 20, the alignment film 32 is formed on a surface of the support 30.

The alignment film 32 is an alignment film for aligning the liquid crystal compound 40 to a predetermined liquid crystal alignment pattern during the formation of the cholesteric liquid crystal layer 34.

As described above, in the present invention, the cholesteric liquid crystal layer 34 has a liquid crystal alignment pattern in which a direction of an optical axis 40A derived from the liquid crystal compound 40 changes while continuously rotating in one in-plane direction (refer to FIG. 5). Accordingly, the alignment film 32 is formed such that the cholesteric liquid crystal layer 34 can form the liquid crystal alignment pattern.

In the following description, “the direction of the optical axis 40A rotates” will also be simply referred to as “the optical axis 40A rotates”.

As the alignment film 32, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett’s method using an organic compound such as ω-tricosanoic acid, dioctadecylmethylammonium chloride, or methyl stearate.

The alignment film 32 formed by a rubbing treatment can be formed by rubbing a surface of a polymer layer with paper or fabric in a given direction multiple times.

As the material used for the alignment film 32, for example, a material for forming polyimide, polyvinyl alcohol, a polymer having a polymerizable group described in JP1997-152509A (JP-H9-152509A), or an alignment film 32 such as JP2005-97377A, JP2005-99228A, and JP2005-128503A is preferable.

The alignment film 32 can be suitably used as a so-called photo-alignment film obtained by irradiating a photo-alignment material with polarized light or non-polarized light. That is, a photo-alignment film that is formed by applying a photo-alignment material to the support 30 is suitably used as the alignment film 32.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

For example, the thickness of the alignment film 32 is preferably 0.01 to 5 µm and more preferably 0.05 to 2 µm.

A method of forming the alignment film 32 is not limited. Any one of various well-known methods corresponding to a material for forming the alignment film 32 can be used. For example, a method including: applying the alignment film 32 to a surface of the support 30; drying the applied alignment film 32; and exposing the alignment film 32 to laser light to form an alignment pattern can be used.

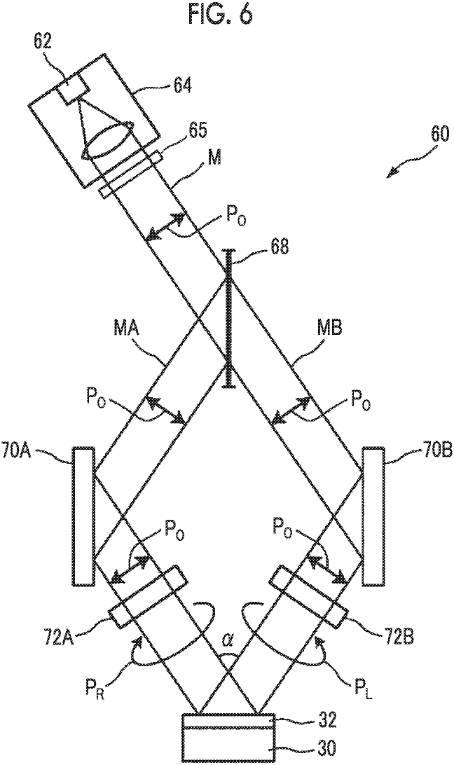

FIG. 6 conceptually shows an example of an exposure device that exposes the alignment film 32 to form an alignment pattern.

An exposure device 60 shown in FIG. 6 includes: a light source 64 including a laser 62; an λ/2 plate 65 that changes a polarization direction of laser light M emitted from the laser 62; a polarization beam splitter 68 that splits the laser light M emitted from the laser 62 into two beams MA and MB; mirrors 70A and 70B that are disposed on optical paths of the splitted two beams MA and MB; and λ/4 plates 72A and 72B.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 30 including the alignment film 32 on which the alignment pattern is not yet formed is disposed at an exposed portion, the two beams MA and MB intersect and interfere with each other on the alignment film 32, and the alignment film 32 is irradiated with and exposed to the interference light.

Due to the interference in this case, the polarization state of light with which the alignment film 32 is irradiated periodically changes according to interference fringes. As a result, an alignment film (hereinafter, also referred to as “patterned alignment film”) having an alignment pattern in which the alignment state changes periodically is obtained.

In the exposure device 60, by changing an intersecting angle α between the two beams MA and MB, the period of the alignment pattern can be adjusted. That is, by adjusting the intersecting angle α in the exposure device 60, in the alignment pattern in which the optical axis 40A derived from the liquid crystal compound 40 continuously rotates in the one in-plane direction, the length of the single period over which the optical axis 40A rotates by 180° in the one in-plane direction in which the optical axis 40A rotates can be adjusted.

By forming the cholesteric liquid crystal layer on the alignment film 32 having the alignment pattern in which the alignment state periodically changes, as described below, the cholesteric liquid crystal layer 34 having the liquid crystal alignment pattern in which the optical axis 40A derived from the liquid crystal compound 40 continuously rotates in the one in-plane direction can be formed.

In addition, by rotating the optical axes of the λ/4 plates 72A and 72B by 90°, respectively, the rotation direction of the optical axis 40A can be reversed.

As described above, the patterned alignment film has the alignment pattern for aligning the liquid crystal compound to have the liquid crystal alignment pattern in which the direction of the optical axis of the liquid crystal compound in the cholesteric liquid crystal layer formed on the patterned alignment film changes while continuously rotating in at least one in-plane direction. In a case where an axis in the direction in which the liquid crystal compound is aligned is an alignment axis, it can be said that the patterned alignment film has an alignment pattern in which the direction of the alignment axis changes while continuously rotating in at least one in-plane direction. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that a direction in which the light amount is the maximum or the minimum gradually changes in the one in-plane direction.

In the present invention, the alignment film 32 is provided as a preferable aspect and is not an essential component.

For example, the following configuration can also be adopted, in which, by forming the alignment pattern on the support 30 using a method of rubbing the support 30, a method of processing the support 30 with laser light or the like, or the like, the cholesteric liquid crystal layer or the like has the liquid crystal alignment pattern in which the direction of the optical axis 40A derived from the liquid crystal compound 40 changes while continuously rotating in at least one in-plane direction. That is, in the present invention, the support 30 may be made to act as the alignment film.

### Cholesteric Liquid Crystal Layer

The cholesteric liquid crystal layer 34 is formed on a surface of the alignment film 32.

As described above, in the incidence element 20 as the optical element according to the embodiment of the present invention, the cholesteric liquid crystal layer 34 is a cholesteric liquid crystal layer that is obtained by immobilizing a cholesteric liquid crystalline phase, and has a liquid crystal alignment pattern in which a direction of an optical axis derived from a liquid crystal compound changes while continuously rotating in at least one in-plane direction.

In addition, in the incidence element 20 as the optical element according to the embodiment of the present invention, the cholesteric liquid crystal layer 34 has the pitch gradient (PG) structure where the helical pitch of the helical structure gradually changes in the thickness direction of the cholesteric liquid crystal layer 34. In the example shown in the drawing, for example, the cholesteric liquid crystal layer 34 has the PG structure where the helical pitch is gradually widened upward in the drawing in the thickness direction, that is, in a direction away from the support 30 (alignment film 32).

Further, in the incidence element 20 as the optical element according to the embodiment of the present invention, the cholesteric liquid crystal layer 34 has a peak of reflection at each of the first wavelength λ and the second wavelength λ/2. The first wavelength λ is originally a peak of reflection corresponding to the selective reflection center wavelength of the cholesteric liquid crystal layer. In addition, the second wavelength λ/2 is a peak of reflection of a wavelength that is substantially half of the first wavelength λ.

As conceptually shown in FIG. 4, the cholesteric liquid crystal layer 34 has a helical structure in which the liquid crystal compound 40 is helically turned and laminated as in a cholesteric liquid crystal layer obtained by immobilizing a typical cholesteric liquid crystalline phase. In the helical structure, a configuration in which the liquid crystal compound 40 is helically rotated once (rotated by 360) and laminated is set as one helical pitch, and plural pitches of the helically turned liquid crystal compounds 40 are laminated.

As is well-known, the cholesteric liquid crystal layer obtained by immobilizing a cholesteric liquid crystalline phase has wavelength-selective reflectivity.

Although described below in detail, the selective reflection wavelength range of the cholesteric liquid crystal layer depends on the length of one helical pitch described above in the thickness direction.

### Cholesteric Liquid Crystalline Phase

It is known that the cholesteric liquid crystalline phase exhibits selective reflectivity at a specific wavelength.

A central wavelength of selective reflection (selective reflection center wavelength) λ of a general cholesteric liquid crystalline phase depends on a helical pitch P in the cholesteric liquid crystalline phase and satisfies a relationship of λ = n x P with an average refractive index n of the cholesteric liquid crystalline phase. Therefore, the selective reflection center wavelength can be adjusted by adjusting the helical pitch P. The selective reflection center wavelength of the cholesteric liquid crystalline phase increases as the helical pitch P increases.

In the present invention, light having a wavelength to be reflected according to the relationship of λ = n x P is primary reflected light described below.

As described above, the helical pitch P refers to one pitch (helical period) of the helical structure of the cholesteric liquid crystalline phase, in other words, one helical turn. That is, the helical pitch refers to the length in a helical axis direction in which a director (in the case of a rod-like liquid crystal, a major axis direction) of the liquid crystal compound constituting the cholesteric liquid crystalline phase rotates by 360°.

The helical pitch of the cholesteric liquid crystalline phase depends on the kind of the chiral agent used together with the liquid crystal compound and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), pp. 60 to 63. As a method of measuring a sense of helix and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric liquid crystalline phase exhibits selective reflectivity with respect to left or circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystal layer is right, right circularly polarized light is reflected, and in a case where the helical twisted direction of the cholesteric liquid crystal layer is left, left circularly polarized light is reflected.

A twisted direction of the cholesteric liquid crystalline phase can be adjusted by adjusting the kind of the liquid crystal compound that forms the cholesteric liquid crystal layer and/or the kind of the chiral agent to be added.

In addition, a half-width Δλ (nm) of a selective reflection wavelength range (circularly polarized light reflection wavelength range) where selective reflection is exhibited, that is, the half-width of the primary light depends on Δn of the cholesteric liquid crystalline phase and the helical pitch P and complies with a relationship of Δλ = Δn x P. Therefore, the width of the selective reflection wavelength range of the primary light can be controlled by adjusting Δn. Δn can be adjusted by adjusting a kind of a liquid crystal compound for forming the cholesteric liquid crystal layer and a mixing ratio thereof, and a temperature during alignment immobilization.

In a case where a cross-section of the cholesteric liquid crystal layer in the thickness direction is observed with a SEM, a stripe pattern where bright portions and dark portions derived from a cholesteric liquid crystalline phase are alternately provided is observed.

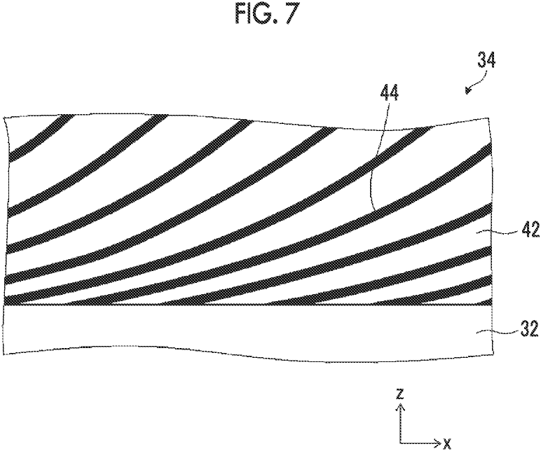

In a case where an X-Z plane of the cholesteric liquid crystal layer 34 shown in FIG. 4, that is, a cross-section of the cholesteric liquid crystal layer having the above-described liquid crystal alignment pattern in the thickness direction is observed with an SEM, a stripe pattern in which bright portions 42 and dark portions 44 are tilted with respect to the main surface (X-Y plane) as conceptually shown in FIG. 7 is observed.

Here, the cholesteric liquid crystal layer 34 has the PG structure where the helical pitch is gradually widened upward in the drawing in the thickness direction, that is, in the direction away from the support 30 (alignment film 32). Therefore, in a case where the cross-section of the cholesteric liquid crystal layer 34 is observed with the SEM, the bright portions 42 and the dark portions 44 have a curved shape in which an interval of the bright portions 42 and the dark portions 44 is gradually widened upward in the drawing, that is, in the direction away from the alignment film 32 as shown in FIG. 7.

In this SEM cross-section, an interval between the bright portions 42 adjacent to each other or between the dark portions 44 adjacent to each other in a normal direction of lines formed by the bright portions 42 or the dark portions 44 corresponds to a ½ pitch. That is, in FIG. 7, two bright portions 42 and two dark portions 44 correspond to one helical pitch (one helical turn), that is, the helical pitch P.

Accordingly, the helical axis of the helical structure of the cholesteric liquid crystal layer 34 having the above-described liquid crystal alignment pattern and the PG structure is normally parallel to a normal direction of lines formed by the bright portions 42 and the dark portions 44. That is, in the cholesteric liquid crystal layer 34, the direction of the helical axis also changes in the thickness direction.

Further, in the cholesteric liquid crystal layer 34 having the above-described liquid crystal alignment pattern and the PG structure, the optical axis of the liquid crystal compound 40, that is, the molecular axis is tilted along the bright portions 42 and the dark portions 44.

### Method of Forming Cholesteric Liquid Crystal Layer

The cholesteric liquid crystal layer can be formed by immobilizing a cholesteric liquid crystalline phase in a layer shape.

The structure in which a cholesteric liquid crystalline phase is immobilized may be a structure in which the alignment of the liquid crystal compound as a cholesteric liquid crystalline phase is immobilized. Typically, the structure in which a cholesteric liquid crystalline phase is immobilized is preferably a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a cholesteric liquid crystalline phase is immobilized is not particularly limited as long as the optical characteristics of the cholesteric liquid crystalline phase are maintained, and the liquid crystal compound 40 in the cholesteric liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the cholesteric liquid crystal layer obtained by immobilizing a cholesteric liquid crystalline phase include a liquid crystal composition including a liquid crystal compound. It is preferable that the liquid crystal compound is a polymerizable liquid crystal compound.

In addition, the liquid crystal composition used for forming the cholesteric liquid crystal layer may further include a surfactant and a chiral agent.

### Polymerizable Liquid Crystal Compound

The polymerizable liquid crystal compound may be a rod-like liquid crystal compound or a disk-like liquid crystal compound.

Examples of the rod-like polymerizable liquid crystal compound for forming the cholesteric liquid crystalline phase include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem. (1989), Vol. 190, p. 2255, Advanced Materials (1993), Vol. 5, p. 107, US4683327A, US5622648A, US5770107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

### Disk-Like Liquid Crystal Compound

As the disk-like liquid crystal compound, for example, compounds described in JP2007-108732A and JP2010-244038A can be preferably used.

In addition, the addition amount of the polymerizable liquid crystal compound in the liquid crystal composition is preferably 75% to 99.9 mass%, more preferably 80% to 99 mass%, and still more preferably 85% to 90 mass% with respect to the solid content mass (mass excluding a solvent) of the liquid crystal composition.

### Surfactant

The liquid crystal composition used for forming the cholesteric liquid crystal layer may include a surfactant.

It is preferable that the surfactant is a compound that can function as an alignment control agent contributing to the stable or rapid alignment of a cholesteric liquid crystalline phase. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

As the surfactant, one kind may be used alone, or two or more kinds may be used in combination.

As the fluorine-based surfactant, a compound described in paragraphs “0082” to “0090” of JP2014-119605A is preferable.

The addition amount of the surfactant in the liquid crystal composition is preferably 0.01 to 10 mass%, more preferably 0.01 to 5 mass%, and still more preferably 0.02 to 1 mass% with respect to the total mass of the liquid crystal compound.

### Chiral Agent (Optically Active Compound)

The chiral agent has a function of causing a helical structure of a cholesteric liquid crystalline phase to be formed. The chiral agent may be selected depending on the purpose because a helical twisted direction or a helical pitch derived from the compound varies.

In order to form the cholesteric liquid crystal layer 34 having the PG structure, the chiral agent in which back isomerization, dimerization, isomerization, dimerization or the like occurs during light irradiation such that the helical twisting power (HTP) changes is used. By irradiating the liquid crystal composition with light having a wavelength at the HTP of the chiral agent changes before or during the curing of the liquid crystal composition for forming the cholesteric liquid crystal layer, the cholesteric liquid crystal layer having the PG structure can be formed.

In a chiral agent in which the HTP decreases during light irradiation, in general, HTP decreases during light irradiation.

As the chiral agent, any well-known chiral agents can be used as long as the HTP thereof changes by light irradiation. A chiral agent having a molar absorption coefficient of 30000 or higher at a wavelength of 313 nm is preferably used.

The chiral agent has a function of causing a helical structure of a cholesteric liquid crystalline phase to be formed. The chiral compound may be selected depending on the purpose because a helical sense or a helical pitch induced from the compound varies.

As the chiral agent, a well-known compound can be used, but a compound having a cinnamoyl group is preferable.

Examples of the chiral agent include compounds described in Liquid Crystal Device Handbook (No. 142 Committee of Japan Society for the Promotion of Science, 1989), Chapter 3, Article 4-3, chiral agent for TN or STN, p. 199), JP2003-287623A, JP2002-302487A, JP2002-80478A, JP2002-80851A, JP2010-181852A, and JP2014-034581A.

In general, the chiral agent includes an asymmetric carbon atom. However, an axially asymmetric compound or a planar asymmetric compound not having an asymmetric carbon atom can also be used as the chiral agent. Examples of the axially asymmetric compound or the planar asymmetric compound include binaphthyl, helicene, paracyclophane, and derivatives thereof. The chiral agent may include a polymerizable group.

In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group included in the polymerizable chiral agent is the same as the polymerizable group included in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

As the chiral agent, an isosorbide derivative, an isomannide derivative, or a binaphthyl derivative can be preferably used. As the isosorbide derivative, a commercially available product such as LC-756 (manufactured by BASF SE) may be used.

The content of the chiral agent in the liquid crystal composition is preferably 0.01% to 200 mol% and more preferably 1% to 30 mol% with respect to the amount of the liquid crystal compound.

The cholesteric liquid crystal layer 34 having the PG structure is formed of a liquid crystal composition including the chiral agent where the HTP changes by light irradiation, and can be formed by light irradiation for changing the HTP of the chiral agent before the curing of the liquid crystal composition.

### Polymerization Initiator

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator is a photopolymerization initiator which initiates a polymerization reaction with ultraviolet irradiation.

Examples of the photopolymerization initiator include an α-carbonyl compound (described in US2367661A and US2367670A), an acyloin ether (described in US2448828A), an α-hydrocarbon-substituted aromatic acyloin compound (described in US2722512A), a polynuclear quinone compound (described in US3046127A and US2951758A), a combination of a triarylimidazole dimer and p-aminophenyl ketone (described in US3549367A), an acridine compound and a phenazine compound (described in JP1985-105667A (JP-S60-105667A) and US4239850A), and an oxadiazole compound (described in US4212970A).

In particular, it is preferable that the polymerization initiator is a dichroic polymerization initiator.

The dichroic polymerization initiator refers to a polymerization initiator that has absorption selectivity with respect to light in a specific polarization direction and is excited by the polarized light to generate a free radical among photopolymerization initiators. That is, the dichroic polymerization initiator refers to a polymerization initiator having different absorption selectivities between light in a specific polarization direction and light in a polarization direction perpendicular to the light in the specific polarization direction.

The details and specific examples of the dichroic polymerization initiator are described in WO2003/054111A.

Specific examples of the dichroic polymerization initiator include polymerization initiators represented by the following chemical formulae. In addition, as the dichroic polymerization initiator, a polymerization initiator described in paragraphs “0046” to “0097” of JP2016-535863A.

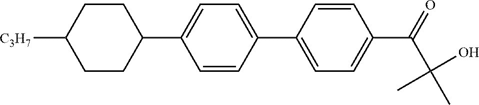

The content of the photopolymerization initiator in the liquid crystal composition is preferably 0.1 to 20 mass% and more preferably 0.5 to 12 mass% with respect to the content of the liquid crystal compound.

### Crosslinking Agent

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these crosslinking agents, one kind may be used alone, or two or more kinds may be used in combination.

The content of the crosslinking agent is preferably 3% to 20 mass% and more preferably 5% to 15 mass% with respect to the solid content mass of the liquid crystal composition. In a case where the content of the crosslinking agent is in the above-described range, an effect of improving a crosslinking density can be easily obtained, and the stability of a cholesteric liquid crystalline phase is further improved.

### Other Additives

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

In a case where the cholesteric liquid crystal layer is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. Among these organic solvents, one kind may be used alone, or two or more kinds may be used in combination. Among these, a ketone is preferable in consideration of an environmental burden.

In a case where the cholesteric liquid crystal layer is formed, it is preferable that the cholesteric liquid crystal layer is formed by applying the liquid crystal composition to a surface where the cholesteric liquid crystal layer is to be formed, aligning the liquid crystal compound to a state of a cholesteric liquid crystalline phase, and curing the liquid crystal compound.

That is, in a case where the cholesteric liquid crystal layer is formed on the alignment film 32, it is preferable that the cholesteric liquid crystal layer obtained by immobilizing a cholesteric liquid crystalline phase is formed by applying the liquid crystal composition to the alignment film 32, aligning the liquid crystal compound to a state of a cholesteric liquid crystalline phase, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the cholesteric liquid crystal layer. In the drying and/or heating step, the liquid crystal compound in the liquid crystal composition only has to be aligned to a cholesteric liquid crystalline phase. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

Although described below, in the optical element according to the embodiment of the present invention, the cholesteric liquid crystal layer has the PG structure where the helical pitch of the cholesteric liquid crystalline phase gradually changes in the thickness direction.

Further, in the optical element according to the embodiment of the present invention, the cholesteric liquid crystal layer has a peak of reflection at each of the first wavelength λ and the second wavelength λ/2, and that is, has the refractive index ellipsoid in which the angle between the molecular axes of the adjacent liquid crystal compounds gradually changes in a view from the helical axis direction.

Therefore, in order to form the cholesteric liquid crystal layer of the optical element according to the embodiment of the present invention, the liquid crystal composition is applied and is irradiated with light for changing the HTP of the chiral agent in the liquid crystal composition. Next, the alignment of the cholesteric liquid crystalline phase by drying and/or heating is performed. Next, irradiation of polarized light for forming the refractive index ellipsoid is performed. Next, the liquid crystal composition is cured and further polymerized.

The thickness of the cholesteric liquid crystal layer is not particularly limited, and the thickness with which a required light reflectivity can be obtained may be appropriately set depending on the use of the cholesteric liquid crystal layer, the light reflectivity required for the cholesteric liquid crystal layer, the material for forming the cholesteric liquid crystal layer, and the like.

### Liquid Crystal Elastomer

A liquid crystal elastomer may be used for the cholesteric liquid crystal layer according to the embodiment of the present invention.

The liquid crystal elastomer is a hybrid material of liquid crystal and an elastomer.

The liquid crystal elastomer has a structure in which a liquid crystalline rigid mesogenic group is introduced into a flexible polymer network having rubber elasticity. Therefore, the liquid crystal elastomer has flexible mechanical characteristics and elasticity.

In addition, the alignment state of liquid crystal and the macroscopic shape of the system strongly correlate to each other. In a state where the alignment state of liquid crystal changes depending on a temperature, an electric field, or the like, macroscopic deformation corresponding to a change in alignment degree occurs. For example, in a case where the liquid crystal elastomer is heated up to a temperature at which a nematic phase is transformed into an isotropic phase of random alignment, a sample contracts in a director direction, and the contraction amount thereof increases along with a temperature increase, that is, the alignment degree of liquid crystal decreases. The deformation is thermoreversible, and the liquid crystal elastomer returns to its original shape in a case where it is cooled to the temperature of the nematic phase again.

On the other hand, in a case where the liquid crystal elastomer of the cholesteric phase is heated such that the alignment degree of liquid crystal decreases, the macroscopic elongational deformation of the helical axis direction occurs. Therefore, the helical pitch length decreases, and the reflection center wavelength of the selective reflection peak is shifted to a longer wavelength side. This change is also thermoreversible, and as the liquid crystal elastomer is cooled, the reflection center wavelength returns to a shorter wavelength side.

### Liquid Crystal Alignment Pattern of Cholesteric Liquid Crystal Layer

As described above, in the cholesteric liquid crystal layer, the cholesteric liquid crystal layer has the liquid crystal alignment pattern in which the direction of the optical axis 40A derived from the liquid crystal compound 40 forming the cholesteric liquid crystalline phase changes while continuously rotating in the one in-plane direction of the cholesteric liquid crystal layer.

The optical axis 40A derived from the liquid crystal compound 40 is an axis having the highest refractive index in the liquid crystal compound 40, that is, a so-called slow axis. For example, in a case where the liquid crystal compound 40 is a rod-like liquid crystal compound, the optical axis 40A is parallel to a rod-like major axis direction. In the following description, the optical axis 40A derived from the liquid crystal compound 40 will also be referred to as “the optical axis 40A of the liquid crystal compound 40” or “the optical axis 40A”.

FIG. 5 conceptually shows a plan view of the cholesteric liquid crystal layer 34.

The plan view is a view in a case where the cholesteric liquid crystal layer 34 is seen from the top in FIG. 4, that is, a view in a case where the cholesteric liquid crystal layer 34 is seen from a thickness direction (laminating direction of the respective layers (films)).

In addition, in FIG. 5, in order to clarify the configuration of the cholesteric liquid crystal layer (cholesteric liquid crystal layer 34), only the liquid crystal compound 40 on the surface of the alignment film 32 is shown.

As shown in FIG. 5, on the surface of the alignment film 32, the liquid crystal compound 40 forming the cholesteric liquid crystal layer 34 has the liquid crystal alignment pattern in which the direction of the optical axis 40A changes while continuously rotating in the predetermined one in-plane direction indicated by arrow X1 in a plane of the cholesteric liquid crystal layer according to the alignment pattern formed on the alignment film 32 as the lower layer. In the example shown in the drawing, the liquid crystal compound 40 has the liquid crystal alignment pattern in which the optical axis 40A of the liquid crystal compound 40 changes while continuously rotating clockwise in the arrow X1 direction.

The liquid crystal compound 40 forming the cholesteric liquid crystal layer 34 is two-dimensionally arranged in a direction perpendicular to the arrow X1 and the one in-plane direction (arrow X1 direction).

In the cholesteric liquid crystal layer 34 in the example shown in the drawing, the arrow X1 direction matches with the above-described x direction. Accordingly, the y direction is an upper direction in FIG. 5 perpendicular to the arrow X1 direction, and the z direction is a direction perpendicular to the paper plane in FIG. 5.

Accordingly, the y direction is a direction perpendicular to the one in-plane direction in which the direction of the optical axis 40A of the liquid crystal compound 40 changes while continuously rotating in a plane of the cholesteric liquid crystal layer. Accordingly, in FIG. 8 described below, the y direction is a direction perpendicular to the paper plane.

Specifically, “the direction of the optical axis 40A of the liquid crystal compound 40 changes while continuously rotating in the arrow X1 direction (the predetermined one in-plane direction)” represents that an angle between the optical axis 40A of the liquid crystal compound 40, which is arranged in the arrow X1 direction, and the arrow X1 direction varies depending on positions in the arrow X1 direction, and the angle between the optical axis 40A and the arrow X1 direction sequentially changes from θ to θ + 180° or θ - 180° in the arrow X1 direction.

A difference between the angles of the optical axes 40A of the liquid crystal compound 40 adjacent to each other in the arrow X1 direction is preferably 45° or less, more preferably 15° or less, and smaller angles are still more preferable.

On the other hand, in the liquid crystal compound 40 forming the cholesteric liquid crystal layer 34, the directions of the optical axes 40A are the same in the y direction perpendicular to the arrow X1 direction, that is, the y direction perpendicular to the one in-plane direction in which the optical axis 40A continuously rotates.

In other words, in the liquid crystal compound 40 forming the cholesteric liquid crystal layer 34, angles between the optical axes 40A of the liquid crystal compound 40 and the arrow X1 direction are the same in the y direction.

In the cholesteric liquid crystal layer 34, in the liquid crystal alignment pattern of the liquid crystal compound 40, the length (distance) over which the optical axis 40A of the liquid crystal compound 40 rotates by 180° in the arrow X1 direction in which the optical axis 40A changes while continuously rotating in a plane, that is, the length of the single period in the liquid crystal alignment pattern is represented by A.

That is, a distance between centers of two liquid crystal compounds 40 in the arrow X1 direction is the length A of the single period, the two liquid crystal compounds having the same angle in the arrow X1 direction. Specifically, as shown in FIG. 5, a distance of centers in the arrow X1 direction of two liquid crystal compounds 40 in which the arrow X1 direction and the direction of the optical axis 40A match with each other is the length A of the single period. In the following description, the length A of the single period will also be referred to as “single period A”.

In the liquid crystal alignment pattern of the cholesteric liquid crystal layer 34, the single period A is repeated in the arrow X1 direction, that is, in the one in-plane direction in which the direction of the optical axis 40A changes while continuously rotating.

The cholesteric liquid crystal layer obtained by immobilizing a cholesteric liquid crystalline phase typically reflects incident light (circularly polarized light) by specular reflection.

On the other hand, the cholesteric liquid crystal layer 34 having the liquid crystal alignment pattern in which the optical axis 40A continuously changes while rotating in the X1 direction (predetermined one in-plane direction) diffracts and reflects incident light in a state where it is tilted in the arrow X1 direction with respect to specular reflection.

Hereinafter, the action of diffract will be described with reference to FIG. 8.

In order to clearly show the action of diffraction by the cholesteric liquid crystal layer 34, FIG. 8 shows a cholesteric liquid crystal layer not having the PG structure and the refractive index ellipsoid. However, the action of diffraction described below is also the same as in the cholesteric liquid crystal layer 34 having the PG structure and the refractive index ellipsoid. Note that, as described below, the cholesteric liquid crystal layer having the refractive index ellipsoid reflects primary light having a peak at the wavelength λ corresponding to the helical pitch P and secondary light having a peak at the wavelength λ/2.

For example, the cholesteric liquid crystal layer shown in FIG. 8 selectively reflects right circularly polarized light R_{R} of red light. Accordingly, in a case where light is incident into the cholesteric liquid crystal layer, the cholesteric liquid crystal layer reflects only right circularly polarized light R_{R} of red light and allows transmission of the other light.

In a case where the right circularly polarized light R_{R} of red light incident into the cholesteric liquid crystal layer is reflected from the cholesteric liquid crystal layer, the absolute phase changes depending on the directions of the optical axes 40A of the respective liquid crystal compounds 40.

Here, in the cholesteric liquid crystal layer 34, the optical axis 40A of the liquid crystal compound 40 changes while rotating in the arrow X1 direction (the one in-plane direction). Therefore, the amount of change in the absolute phase of the incident right circularly polarized light R_{R} of red light varies depending on the directions of the optical axes 40A.

Further, the liquid crystal alignment pattern formed in the cholesteric liquid crystal layer 34 is a pattern that is periodic in the arrow X1 direction. Therefore, as conceptually shown in FIG. 8, an absolute phase Q that is periodic in the arrow X1 direction corresponding to the direction of the optical axis 40A is assigned to the right circularly polarized light R_{R} of red light incident into the cholesteric liquid crystal layer 34.

In addition, the direction of the optical axis 40A of the liquid crystal compound 40 with respect to the arrow X1 direction is uniform in the arrangement of the liquid crystal compounds 40 in the y direction perpendicular to arrow X1 direction.

As a result, in the cholesteric liquid crystal layer, an equiphase surface E that is tilted in the arrow X1 direction with respect to an XY plane is formed for the right circularly polarized light R_{R} of red light.

Therefore, the right circularly polarized light R_{R} of red light is reflected in the normal direction of the equiphase surface E, and the reflected right circularly polarized light R_{R} of red light is reflected in a direction that is tilted in the arrow X1 direction with respect to the XY plane (main surface of the cholesteric liquid crystal layer).

Accordingly, by appropriately setting the arrow X1 direction as the one in-plane direction in which the optical axis 40A rotates, a direction in which the right circularly polarized light R_{R} of red light is reflected (diffracted) can be adjusted.

That is, by reversing the arrow X1 direction, the reflection direction of the right circularly polarized light R_{R} of red light is opposite to that of FIG. 7.

In addition, by reversing the rotation direction of the optical axis 40A of the liquid crystal compound 40 toward the arrow X1 direction, a reflection direction of the right circularly polarized light R_{R} of red light can be reversed.

That is, in FIGS. 5 and 8, the rotation direction of the optical axis 40A toward the arrow X1 direction is clockwise, and the right circularly polarized light R_{R} of red light is reflected toward the arrow X1 direction. On the other hand, by setting the rotation direction of the optical axis 40Ain the arrow X1 direction to be counterclockwise, the right circularly polarized light R_{R} of red light is reflected in a state where it is tilted in a direction opposite to the arrow X1 direction.

Further, in the cholesteric liquid crystal layer having the same liquid crystal alignment pattern, the reflection direction is reversed by adjusting the helical turning direction of the liquid crystal compound 40, that is, the turning direction of circularly polarized light to be selectively reflected.

The cholesteric liquid crystal layer 34 shown in FIG. 8 has a right-twisted helical turning direction, selectively reflects right circularly polarized light, and has the liquid crystal alignment pattern in which the optical axis 40A rotates clockwise in the arrow X1 direction. As a result, the right circularly polarized light is reflected in a state where it is tilted in the arrow X1 direction.

Accordingly, in the cholesteric liquid crystal layer that has a left-twisted helical turning direction, selectively reflects left circularly polarized light, and has the liquid crystal alignment pattern in which the optical axis 40A rotates clockwise in the arrow X1 direction, the left circularly polarized light is reflected in a state where it is tilted in a direction opposite to the arrow X1 direction.

In the cholesteric liquid crystal layer having the liquid crystal alignment pattern, as the single period A decreases, the diffraction increases. That is, in the cholesteric liquid crystal layer having the liquid crystal alignment pattern, as the single period A decreases, the angle of reflected light with respect to incidence light largely changes with respect to specular reflection. That is, as the single period A decreases, reflected light can be reflected in a state where it is largely tilted with respect to specular reflection of incidence light.

### Refractive Index Ellipsoid of Cholesteric Liquid Crystal Layer

As described above, the cholesteric liquid crystal layer 34 has a peak of reflection at each of the first wavelength λ and the second wavelength λ/2 that is about half of the first wavelength λ. That is, in a case where the arrangement of the liquid crystal compounds 40 that are cholesterically aligned is seen from the helical axis direction, the cholesteric liquid crystal layer 34 has the refractive index ellipsoid in which the angle between molecular axes of the adjacent liquid crystal compounds 40 gradually changes. In other words, in the cholesteric liquid crystal layer 34 having the refractive index ellipsoid, the helical structure of the cholesteric liquid crystal layer is distorted.

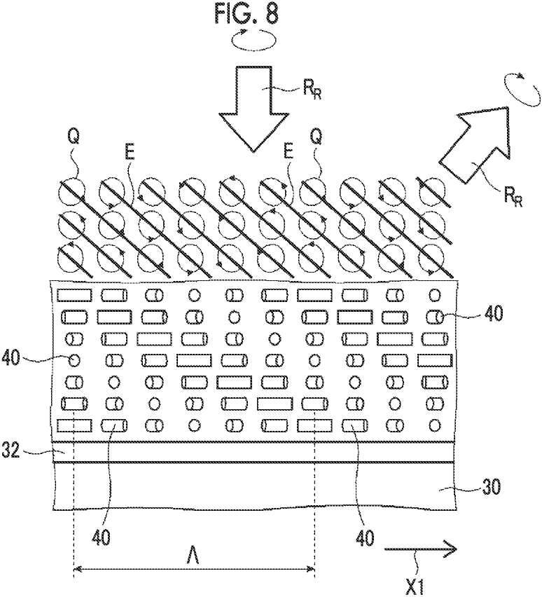

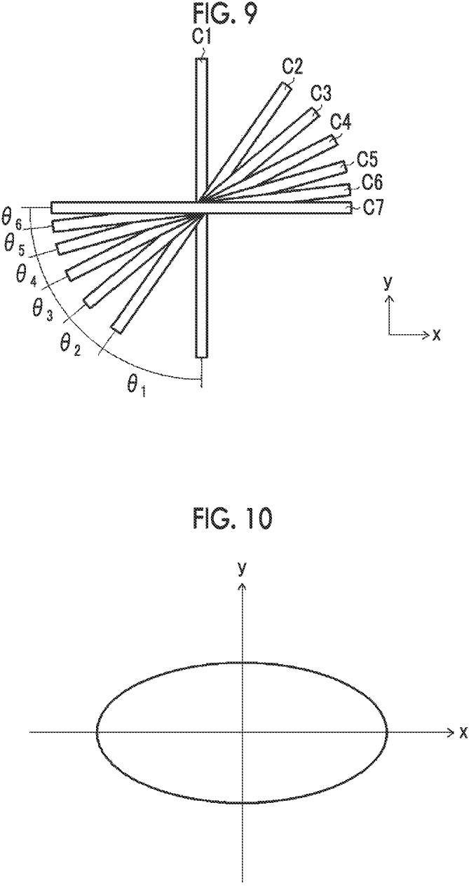

The refractive index ellipsoid will be described using the conceptual diagrams of FIGS. 9 and 10.

As described above, in the cholesteric liquid crystal layer 34 according to the embodiment of the present invention having the PG structure, the helical axis is tilted with respect to the thickness direction of the cholesteric liquid crystal layer 34, that is, the z direction.

However, in order to clearly show the configuration of the refractive index ellipsoid, FIGS. 9 and 10 shows that the direction of the helical axis matches with the thickness direction of the cholesteric liquid crystal layer 34, that is, the z direction.

FIG. 9 is a diagram showing a part (¼ pitch portion) of a plurality of liquid crystal compounds that are twisted and aligned along a helical axis in case of being seen from a helical axis direction (z direction). FIG. 10 is a diagram conceptually showing an existence probability of the liquid crystal compound seen from the helical axis direction.

In FIG. 9, a liquid crystal compound having a molecular axis parallel to the y direction is represented by C1, a liquid crystal compound having a molecular axis parallel to the x direction is represented by C7, and liquid crystal compounds between C1 and C7 are represented by C2 to C6 in order from the liquid crystal compound C1 side to the liquid crystal compound C7 side.

The liquid crystal compounds C1 to C7 are twisted and aligned along the helical axis, and the liquid crystal compound rotates by 90° from the liquid crystal compound C1 to the liquid crystal compound C7.

The length over which the angle between the liquid crystal compounds that are cholesterically aligned, that is, are twisted and aligned changes by 360° is one helical pitch (helical pitch P). Therefore, the length in the helical axis direction between the liquid crystal compound C1 and the liquid crystal compound C7 is ¼ pitch.

The cholesteric liquid crystal layer 34 has the refractive index ellipsoid. Therefore, as shown in FIG. 9, in the ¼ pitch from the liquid crystal compound C1 to the liquid crystal compound C7, the angle between the molecular axes of the liquid crystal compounds adjacent to each other in case of being seen from the helical axis direction varies. As described above, in the cholesteric liquid crystal layer 34, since the liquid crystal compound 40 is a rod-like liquid crystal compound, the molecular axis matches with the optical axis.

In the example shown in FIG. 9, an angle θ₁ between the liquid crystal compound C1 and the liquid crystal compound C2 is more than an angle θ₂ between the liquid crystal compound C2 and the liquid crystal compound C3, the angle θ₂ between the liquid crystal compound C2 and the liquid crystal compound C3 is more than an angle θ₃ between the liquid crystal compound C3 and the liquid crystal compound C4, the angle θ₃ between the liquid crystal compound C3 and the liquid crystal compound C4 is more than an angle θ₄ between the liquid crystal compound C4 and the liquid crystal compound C5, the angle θ₄ between the liquid crystal compound C4 and the liquid crystal compound C5 is more than an angle θ₅ between the liquid crystal compound C5 and the liquid crystal compound C6, the angle θ₅ between the liquid crystal compound C5 and the liquid crystal compound C6 is more than an angle θ₆ between the liquid crystal compound C6 and the liquid crystal compound C7, and the angle θ₆ between the liquid crystal compound C6 and the liquid crystal compound C7 is the smallest.

That is, the liquid crystal compounds C1 to C7 are helically twisted and aligned such that the angle between the molecular axes of the liquid crystal compounds adjacent to each other in the helical turning direction decreases in order from the liquid crystal compound C1 side toward the liquid crystal compound C7 side.

For example, in a case where the interval between the liquid crystal compounds in the helical axis direction is substantially regular, the rotation angle per unit length in the helical axis direction decreases in order from the liquid crystal compound C1 side to the liquid crystal compound C7 side in the ¼ pitch from the liquid crystal compound C1 to the liquid crystal compound C7.

In the cholesteric liquid crystal layer 34, the configuration in which the rotation angle per unit length in the helical axis direction changes as described above in the ¼ pitch is repeated such that the liquid crystal compound is helically twisted and aligned.

Here, in a case where the rotation angle per unit length is constant, the angle between the molecular axes of the liquid crystal compounds adjacent to each other is constant. Therefore, as conceptually shown in FIG. 14, the existence probability of the liquid crystal compound in case of being seen from the helical axis direction is the same in any direction.

On the other hand, as described above, with the rotation angle per unit length decreases in order from the liquid crystal compound C1 side to the liquid crystal compound C7 side in the ¼ pitch from the liquid crystal compound C1 to the liquid crystal compound C7, the existence probability of the liquid crystal compound in case of being seen from the helical axis direction in the x direction is higher than that in the y direction as conceptually shown in FIG. 10. By making the existence probability of the liquid crystal compound to vary between the x direction and the y direction, the refractive index varies between the x direction and the y direction such that refractive index anisotropy occurs. In other words, refractive index anisotropy in a plane perpendicular to the helical axis occurs.

Accordingly, in a case where the cholesteric liquid crystal layer 34 is seen from the plane direction (the plane direction of the main surface), the refractive index nx in the x direction in which the existence probability of the liquid crystal compound is higher is higher than the refractive index ny in the y direction in which the existence probability of the liquid crystal compound is lower. That is, in the cholesteric liquid crystal layer 34, the refractive index nx and the refractive index ny satisfy a relationship of nx > ny.

The x direction in which the existence probability of the liquid crystal compound is higher is the in-plane slow axis direction of the cholesteric liquid crystal layer 34, and the y direction in which the existence probability of the liquid crystal compound is lower is the in-plane fast axis direction of the cholesteric liquid crystal layer 34.

This way, the configuration (the configuration having the refractive index ellipsoid) in which the rotation angle per unit length in the ¼ pitch change in the cholesteric alignment, that is, the helically twisted alignment of the liquid crystal compound can be formed by applying a liquid crystal composition for forming the cholesteric liquid crystal layer, aligning the liquid crystal composition to obtain a cholesteric liquid crystalline phase, irradiating the cholesteric liquid crystalline phase (composition layer) with polarized light in a direction perpendicular to the thickness direction (z direction), that is, for example, in the plane direction such as the x direction.

During the formation of the cholesteric liquid crystal layer 34, in order to form the PG structure before the irradiation of polarized light for forming the refractive index ellipsoid, the light irradiation (ultraviolet irradiation) for changing the HTP of the chiral agent is performed as described above.

Specifically, in a case where polarized light in the plane direction, for example, polarized light in the x direction is irradiated, the polymerization of the liquid crystal compound having a molecular axis in a direction that matches a polarization direction of irradiated polarized light progresses. In this case, only a part of the liquid crystal compound is polymerized. Therefore, a chiral agent present at this position is excluded and moves to another position.

Accordingly, at a position where the direction of the molecular axis of the liquid crystal compound is close to the polarization direction, the amount of the chiral agent decreases, and the rotation angle of the twisted alignment decreases. On the other hand, at a position where the direction of the molecular axis of the liquid crystal compound is perpendicular to the polarization direction, the amount of the chiral agent increases, and the rotation angle of the twisted alignment increases.

As a result, as shown in FIG. 9, the liquid crystal compound that is twisted and aligned along the helical axis can be configured such that, in the ¼ pitch from the liquid crystal compound having the molecular axis parallel to the polarization direction to the liquid crystal compound having the molecular axis perpendicular to the polarization direction, the angle between the molecular axes of the liquid crystal compounds adjacent to each other decreases in order from the liquid crystal compound side parallel to the polarization direction to the liquid crystal compound side perpendicular to the polarization direction.

That is, by irradiating the cholesteric liquid crystalline phase with polarized light, the existence probability of the liquid crystal compound varies between the x direction and the y direction, the refractive index varies between the x direction and the y direction such that the refractive index ellipsoid can be formed.

In addition, by having the refractive index ellipsoid, refractive index anisotropy where the refractive index varies between the x direction and the y direction occurs. As a result, the refractive index nx and the refractive index ny of the optical element satisfy a relationship of nx > ny.

This polarized light irradiation may be performed at the same time as the immobilization of the cholesteric liquid crystalline phase, the immobilization may be further performed by non-polarized light irradiation after the polarized light irradiation, and photo-alignment may be performed by polarized light irradiation after performing the immobilization by non-polarized light irradiation.

In order to form the refractive index ellipsoid where a difference between the existence probabilities of the liquid crystal compounds is large, it is preferable to perform only polarized light irradiation or to previously perform polarized light irradiation for forming the refractive index ellipsoid.

It is preferable to perform the polarized light irradiation in an inert gas atmosphere where the oxygen concentration is 0.5% or less. The irradiation energy is preferably 20 mJ/cm² to 10 J/cm² and more preferably 100 to 800 mJ/cm². The illuminance is preferably 20 to 1000 mW/cm², more preferably 50 to 500 mW/cm², and still more preferably 100 to 350 mW/cm².

The kind of the liquid crystal compound to be cured by polarized light irradiation is not particularly limited, and a liquid crystal compound having an ethylenically unsaturated group as a reactive group is preferable.

By increasing the intensity of the polarized light irradiation, a change in the angle between the molecular axes of the liquid crystal compounds 40 increases. That is, by increasing the intensity of the polarized light irradiation, the distortion of the cholesteric liquid crystalline phase (the distortion of the helical structure) with respect to a typical helical structure increases.

As a result, a difference between the refractive index nx and the refractive index ny of the optical element increases, and the diffraction efficiency of the secondary light described below, that is, the light intensity of the secondary light increases. That is, in the optical element according to the embodiment of the present invention, as the distortion of the cholesteric liquid crystalline phase increases, the diffraction efficiency of the secondary light increases.

The adjustment of the intensity of the polarized light irradiation may be performed by performing the adjustment of the irradiation energy of polarized light to be irradiated, the adjustment of the illuminance of polarized light to be irradiated, the irradiation of the irradiation time of polarized light, and the like.

In addition, examples of a method of forming the refractive index ellipsoid by polarized light irradiation include a method using a dichroic liquid crystalline polymerization initiator (WO2003/054111A1) and a method using a rod-like liquid crystal compound having a photo-alignable functional group such as a cinnamoyl group in the molecule (JP2002-6138A).

The light to be irradiated may be ultraviolet light, visible light, or infrared light. That is, the light with which the liquid crystal compound is polymerizable may be appropriately selected depending on the liquid crystal compound including a coating film, the polymerization initiator, and the like.

In a case where the composition layer is irradiated with polarized light by using the dichroic polymerization initiator as the polymerization initiator, the polymerization of the liquid crystal compound having a molecular axis in a direction that matches the polarization direction can be more suitably made to progress.

As a result, the refractive index ellipsoid where a difference between the existence probabilities of the liquid crystal compounds is large can be formed.

In the optical element according to the embodiment of the present invention, the difference between the refractive index nx and the refractive index ny of the cholesteric liquid crystal layer 34 is not particularly limited and is preferably 0.1 or more, more preferably 0.15 or more, and still more preferably 0.2 or more.

The in-plane slow axis direction, the in-plane fast axis direction, the refractive index nx, and the refractive index ny of the cholesteric liquid crystal layer may be measured, for example, using M-2000 UI (manufactured by J. A. Woollam Co., Ltd.) as a spectroscopic ellipsometer.

The refractive index nx and the refractive index ny can be obtained from a measured value of a retardation Δn x d using measured values of an average refractive index nave and a thickness d. Here, Δn = nx - ny, and the average refractive index nave = (nx + ny) / 2. In general, since the average refractive index of liquid crystal is about 1.5, nx and ny can be obtained using this value.

In a case where the in-plane slow axis direction, the fast axis direction, the refractive index nx, and the refractive index ny of the cholesteric liquid crystal layer are measured, it is preferable that a wavelength longer than the selective reflection center wavelength is the measurement wavelength. That is, in the case of the present invention, it is preferable that a wavelength longer than the reflection wavelength range including the first wavelength λ of the primary light corresponding to the selective reflection center wavelength is the measurement wavelength. For example, it is preferable that the refractive index nx and the like are measured at a wavelength longer than the reflection wavelength range including the first wavelength λ by 100 nm from a longer wavelength side end.

As a result, the influence of retardation derived from the selective reflection of the cholesteric liquid crystal layer on a rotary polarization component is reduced as far as possible. Therefore, the measurement can be performed with high accuracy.

In addition, the cholesteric liquid crystal layer having the refractive index ellipsoid can be formed by stretching the cholesteric liquid crystal layer after applying the liquid crystal composition for forming the cholesteric liquid crystal layer, after immobilizing the cholesteric liquid crystalline phase, or in a state where the cholesteric liquid crystalline phase is semi-immobilized.

In a case where the cholesteric liquid crystal layer having the refractive index ellipsoid is formed by stretching, the stretching may be monoaxial stretching or biaxial stretching. In addition, stretching conditions may be appropriately set depending on the material, the thickness, the desired refractive index nx, and the desired refractive index ny of the cholesteric liquid crystal layer. In the case of monoaxial stretching, the stretching ratio is preferably 1.1 to 4. In the case of biaxial stretching, a ratio between the stretching ratio of one stretching direction and the stretching ratio of another stretching direction is preferably 1.1 to 2.

### Action of Cholesteric Liquid Crystal Layer Having Refractive Index Ellipsoid

An action of the cholesteric liquid crystal layer (optical element) having the Refractive index ellipsoid will be described below in detail.

As shown in FIG. 2 (and FIG. 8), in a case where incidence light L₁ is incident into the cholesteric liquid crystal layer 34 having the liquid crystal alignment pattern from the normal direction (the direction perpendicular to the main surface), as described above, the incidence light L₁ is reflected as reflected light L₂ in a direction tilted with respect to specular reflection by an equiphase surface E that is formed by the alignment of the liquid crystal compound in the cholesteric liquid crystal layer 34.

The reflected light L₂ is light having a wavelength corresponding to the helical pitch P of the cholesteric liquid crystal layer 34, that is, primary light (primary diffracted light) reflected by the cholesteric liquid crystal layer 34. Accordingly, the peak wavelength of the reflected light L₂ is the first wavelength λ corresponding to the selective reflection center wavelength of the cholesteric liquid crystal layer. In the following description, the primary light of the reflected light will also referred to as “primary reflected light”.

Here, as a result of an investigation, the present inventors found that, in a case where the cholesteric liquid crystal layer 34 has not only the liquid crystal alignment pattern but also the refractive index ellipsoid, in addition to the primary reflected light L₂, reflected light L₃ is reflected as secondary light (secondary diffracted light) of diffraction. In the following description, the secondary light of reflection will also referred to as “secondary reflected light”.

Further, the present inventor found that the secondary reflected light has the following characteristics.

First, the peak wavelength of reflection of the secondary reflected light is the length that is substantially half of the peak of reflection of the primary reflected light, that is, the selective reflection center wavelength. Accordingly, the peak wavelength of the secondary reflected light is the second wavelength λ/2 in the present invention.

That is, in a case where the incidence light L₁ is incident into the cholesteric liquid crystal layer, as conceptually indicated by a broken line in FIG. 11, in addition to the reflected light L2 that is primary reflected light having the first wavelength λ as the peak, the reflected light L₃ that is the secondary reflected light having the second wavelength λ/2 as the peak is reflected.

In addition, the reflected light L2 as the primary reflected light and the reflected light L3 as the secondary reflected light have the same angle of diffraction (reflection).

A diffraction angle θ of diffracted light is obtained from “n * sinθ = mλ/p”. In the above expression, n represents a refractive index, m represents a degree, λ represents a wavelength of light, and p represents a period of the diffraction element. In the present invention, the period p the length A (refer to FIG. 5) of the single period in the liquid crystal alignment pattern of the above-described cholesteric liquid crystal layer 34.

As described above, the wavelength of the secondary reflected light is the length that is substantially half of the wavelength of the primary reflected light. Accordingly, in the expression “n * sinθ = mλ/p”, even in a case where the degree is doubled to 2 from 1 of the primary reflected light, the wavelength λ is halved and canceled out, and the diffraction angle θ is the same. Accordingly, the primary reflected light and the secondary reflected light have the same diffraction angle θ, and the secondary reflected light is reflected at the same angle as the primary reflected light.

Further, the reflected light L2 as the primary reflected light is any one of right circularly polarized light or left circularly polarized light depending on the helical turning direction of the liquid crystal compound in the cholesteric liquid crystalline phase.

On the other hand, the secondary reflected light includes both of left circularly polarized light and right circularly polarized light.

On the other hand, in a cholesteric liquid crystal layer that has the same liquid crystal alignment pattern but does not have the refractive index ellipsoid, as shown in FIG. 13, in a case where the arrangement of liquid crystal compounds 102 is seen from the helical axis direction, an angle between molecular axes of liquid crystal compounds 102 adjacent to each other is constant. That is, the cholesteric liquid crystal layer does not have the refractive index ellipsoid. Therefore, as conceptually shown in FIG. 14, the existence probability of the liquid crystal compound in case of being seen from the helical axis direction is the same in any direction.

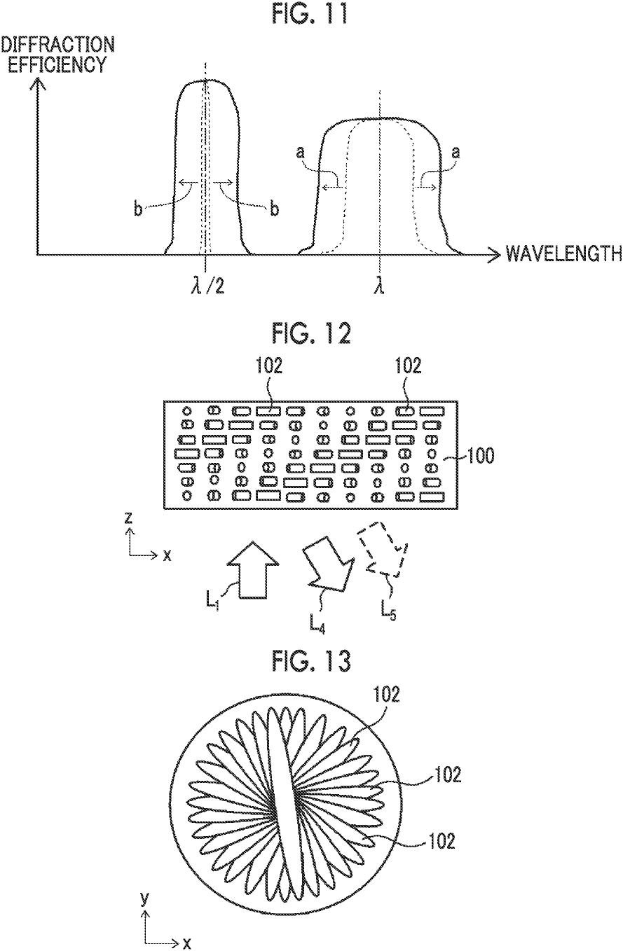

As conceptually shown in FIG. 12, in a case where the incidence light L₁ is incident into the cholesteric liquid crystal layer 100 in the related art from a direction perpendicular to a main surface, as described above, the incidence light L₁ is reflected as reflected light L₄ in a tilted direction by an equiphase surface that is formed by the alignment of the liquid crystal compound in the cholesteric liquid crystal layer 100. The reflected light L₄ is primary reflected light from the cholesteric liquid crystal layer 100.

However, on the other hand, reflected light L₅ (broken line) as the secondary reflected light is not reflected.

This way, in the optical element according to the embodiment of the present invention, the primary reflected light is reflected in the same direction as that of the secondary reflected light. In addition, the secondary reflected light has a wavelength (substantially half) that is largely different from that of the primary reflected light.

Therefore, by using the optical element according to the embodiment of the present invention as the incidence element 20 that causes light (image) to be incident into the light guide plate, two kinds of light components having discontinuous completely different wavelength ranges can be made to be incident into the light guide plate 18 at the same incidence angle where total reflection can occur.

That is, by using the optical element according to the embodiment of the present invention as the incidence element 20, as conceptually shown in FIG. 16, one light guide plate 18 and one incidence element 20 can make two totally different color images that includes an image of a color in a wavelength range including the first wavelength λ and an image of a color including the second wavelength λ/2 to be incident into the light guide plate 18 at the same angle and to be totally reflected and propagate in the same manner.

As a result, in the image display apparatus 10 shown in FIG. 1 that is used in the present invention, one light guide plate 18 and one incidence element 20 can reflect light components in two discontinuous wavelength ranges. For example, in the image display apparatus 10 shown in FIG. 1 that is used in the present invention, one light guide plate 18 and one incidence element 20 can realize AR glasses or the like that uses two color images in totally different wavelength ranges including, for example, a red image corresponding to the first wavelength λ and a blue image corresponding to the second wavelength λ/2.

### Action of Cholesteric Liquid Crystal Layer Having PG Structure

Here, in the cholesteric liquid crystal layer having the refractive index ellipsoid, as indicated by a broken line in FIG. 11, typically, the secondary reflected light corresponding to the second wavelength λ/2 has a significantly narrower bandwidth of reflection wavelength than the primary reflected light corresponding to the first wavelength λ.

Incidentally, as described above, in the image display apparatus 10 such as AR glasses, light that carries and supports an image displayed by the display 14 is incident into the incidence element at various angles. In addition, as is well known, in a case where light is incident into the cholesteric liquid crystal layer (cholesteric liquid crystalline phase) with an angle with respect to a normal line of a main surface, so-called blue shift in which a selective reflection wavelength range is shifted to a shorter wavelength side occurs.

Therefore, the secondary reflected light corresponding to the second wavelength λ/2 having a significantly narrow bandwidth of reflection wavelength can be reflected only when the light in a significantly narrow wavelength range is incident in a significantly narrow angle range from the front.

As a result, in a case where the cholesteric liquid crystal layer having the refractive index ellipsoid is simply used as the incidence element, regarding the image in the wavelength range corresponding to the second wavelength λ/2 among the images in the two wavelength ranges, only light in a significantly narrow wavelength range can be used.

Further, in a case where the cholesteric liquid crystal layer having the refractive index ellipsoid is simply used as the incidence element, for example, in AR glasses or the like, only light emitted from a part of an image display surface of the display 14 can be made to be incident into the light guide plate 18 at an angle where total reflection can occur, and the so-called field of view (FOV) is narrowed.

On the other hand, in the optical element according to the embodiment of the present invention, that is, the incidence element 20, the cholesteric liquid crystal layer 34 has not only the refractive index ellipsoid but also the PG structure.

The PG structure is a structure where the helical pitch of the cholesteric liquid crystalline phase gradually changes in the thickness direction of the cholesteric liquid crystal layer. In the example shown in the drawing, as described above, the PG structure where the helical pitch P of the cholesteric liquid crystalline phase is gradually widened in the direction away from the support 30 (alignment film 32) is provided.

The selective reflection wavelength of the cholesteric liquid crystal layer depends on the helical pitch P of the cholesteric liquid crystalline phase, and as the helical pitch increases, the wavelength of light to be selectively reflected increases.

For example, the reflection wavelength range of the primary reflected light corresponding to the first wavelength λ that is reflected by the cholesteric liquid crystal layer having the PG structure where the helical pitch gradually changes is wider for example, by the amount of arrow a than the cholesteric liquid crystal layer not having the PG structure indicated by a broken line in FIG. 11.

Further, according to the investigation by the present inventors, the cholesteric liquid crystal layer having the refractive index ellipsoid further has the PG structure such that the reflection wavelength ranges of not only the primary reflected light but also the secondary reflected light corresponding to the second wavelength λ/2 are widened as compared to the cholesteric liquid crystal layer not having the PG structure indicated by the broken line in FIG. 11. For example, due to the PG structure, the reflection wavelength range of the secondary reflected light corresponding to the second wavelength λ/2 is widened by the amount of arrow b.

As a result, by using the optical element according to the embodiment of the present invention as the incidence element 20, not only the primary reflected light but also light in a wider wavelength range can be used as an image of the secondary reflected light. Further, for not only the primary reflected light but also an image corresponding to the secondary reflected light, light emitted from the entire surface of the display screen of the display 14 can be made to be incident at an angle where total reflection can occur, and the FOV can be widened.

The PG structure of the cholesteric liquid crystal layer 34 can be formed by performing the light irradiation for changing the HTP of the chiral agent before aligning the liquid crystal compound to the cholesteric liquid crystalline phase using the chiral agent where the HTP changes by light irradiation as described above.

It is assumed that, as the chiral agent in which the HTP changes by light irradiation, a general chiral agent where the HTP decreases by light irradiation is used. In addition, for example, the light irradiation for changing the HTP of the chiral agent is performed from the side opposite to the support 30, that is, from the upper side in FIG. 4 such that there is no influence of the support 30 or the like.

In the following description, the side of the incidence element 20 opposite to the support 30 will also be referred to as the upper side, and the support 30 side will also be referred to as the lower side.

The light that is irradiated for changing the HTP of the chiral agent is absorbed by the component in the liquid crystal composition for forming the cholesteric liquid crystal layer 34, in particular, by the chiral agent.

Accordingly, the irradiation dose of light on the cholesteric liquid crystal layer 34 (liquid crystal composition) gradually decreases from the upper side (the side opposite to the support 30) to the lower side (the support 30 side). Therefore, a decrease in the HTP of the chiral agent by light irradiation gradually decreases from the upper side to the lower alignment film 32 side.

As a result, on the upper side where the decrease in the HTP of the chiral agent is large, the induction of helix is small, and thus the helical pitch increases. On the other hand, on the lower side where the decrease in the HTP of the chiral agent is small, helix is induced by the original HTP of the chiral agent, and thus the helical pitch decreases.

Accordingly, in the example, in the cholesteric liquid crystal layer 34, the helical pitch of the cholesteric liquid crystalline phase gradually decreases from the upper side to the lower side.

The light irradiation for changing the HTP of the chiral agent may be performed using light having a wavelength for which the chiral agent has an absorption. It is preferable to perform ultraviolet irradiation.

During the formation of the cholesteric liquid crystal layer 34, in order to promote the change of the HTP of the chiral agent, it is preferable that ultraviolet irradiation is performed after heating. The liquid crystal composition may be heated to align the liquid crystal compound to a cholesteric liquid crystalline phase.

In order to prevent the cholesteric liquid crystalline phase from being disordered, it is preferable that the temperature during the ultraviolet irradiation is maintained in a temperature range where the cholesteric liquid crystalline phase is exhibited. Specifically, the temperature during the ultraviolet irradiation is preferably 25° C. to 140° C. and more preferably 30° C. to 100° C.

During the ultraviolet irradiation for promoting the change of the HTP of the chiral agent, the oxygen concentration is not particularly limited. Accordingly, the ultraviolet irradiation may be performed in an oxygen atmosphere or in a low oxygen atmosphere.

In the incidence element 20, that is, the optical element according to the embodiment of the present invention, the half-width (full width at half maximum) of the reflection wavelength range of the secondary reflected light corresponding to the second wavelength λ/2 in the cholesteric liquid crystal layer 34 having the PG structure is not limited and may be appropriately set, for example, depending on the width of the FOV required for AR glasses.

For example, in AR glasses, from the viewpoint that a sufficient FOV can be secured, the viewpoint the wavelength range of the image corresponding to the second wavelength λ/2 can be sufficiently widened, and the like, the half-width of the reflection wavelength range of the secondary reflected light is preferably 100 nm or more, more preferably 200 nm or more, and still more preferably 300 nm or more.

The half-width of the reflection wavelength range of the secondary reflected light (primary reflected light) may be adjusted, for example, depending on the kind of the chiral agent to be used, the brightness of light to be irradiated for changing the HTP of the chiral agent, the irradiation time of light to be irradiated for changing the HTP of the chiral agent, and the like.

In the optical element according to the embodiment of the present invention, as described above, the diffraction intensity of the secondary reflected light (reflected light intensity, reflectivity) can be increased by increasing a change in the angle between the molecular axes of the liquid crystal compounds 40 in the cholesteric liquid crystal layer having the refractive index ellipsoid, that is, the distortion of the cholesteric liquid crystalline phase.

In the cholesteric liquid crystal layer 34 in the example shown in the drawing, as shown in FIGS. 3 and 9, the existence probability of the liquid crystal compound is high in the x direction, that is, in the direction in which the direction of the optical axis of the liquid crystal compound changes while continuously rotating in the liquid crystal alignment pattern, and the existence probability in the y direction is low. That is, the direction in which the direction of the optical axis of the liquid crystal compound changes while continuously rotating in the liquid crystal alignment pattern matches the in-plane slow axis direction is adopted, but the present invention is not limited thereto.

That is, in the cholesteric liquid crystal layer of the optical element according to the embodiment of the present invention, a relationship between the direction in which the direction of the optical axis of the liquid crystal compound changes while continuously rotating in the liquid crystal alignment pattern and the in-plane slow axis direction is not particularly limited.

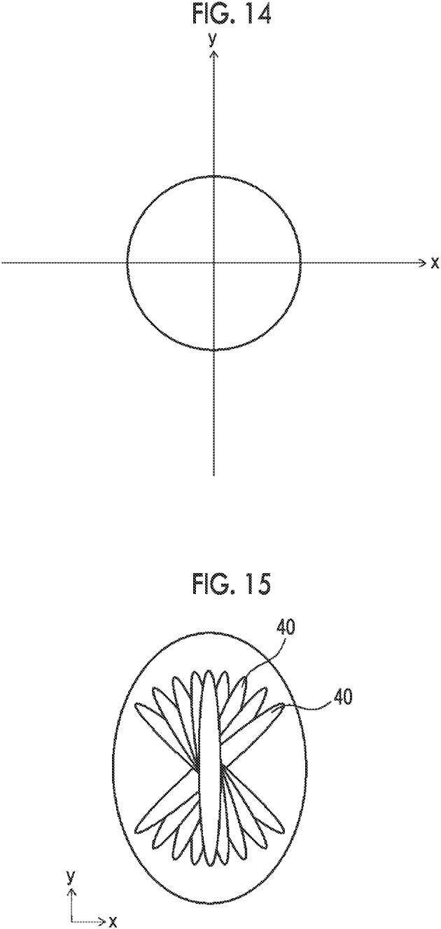

For example, in the example conceptually shown in FIG. 15, the existence probability of the liquid crystal compound may be set to be high in the y direction perpendicular to the direction in which the direction of the optical axis of the liquid crystal compound changes while continuously rotating in the liquid crystal alignment pattern, and the existence probability in the x direction may be set to be low. That is, the direction in which the direction of the optical axis of the liquid crystal compound changes while continuously rotating in the liquid crystal alignment pattern may be substantially perpendicular to the in-plane slow axis direction.

In the image display apparatus 10 shown in FIG. 1, light (light that carries and supports an image) that is displayed by the display 14 and is caused to be incident into the light guide plate 18 by the incidence element 20 at an angle where total reflection can occur propagates in the light guide plate 18 while being repeatedly totally reflected, and is incident into the emission element 24.

The light incident into the emission element 24 is diffracted and reflected by the emission element 24 and is emitted (irradiated) from the light guide plate to the observation position of the image by the user U.

In the light guide element 12 according to the embodiment of the present invention, the emission element 24 is not limited, and various well-known diffraction elements used as an emission element in AR glasses or the like can be used.

For example, a reflective liquid crystal diffraction element described in WO2016/194961A and WO2018/212348A can be used, the reflective liquid crystal diffraction element having a liquid crystal alignment pattern in which an optical axis derived from a liquid crystal compound continuously changes while rotating in one in-plane direction as shown in FIG. 5 as in the optical element according to the embodiment of the present invention and not including a cholesteric liquid crystal layer (optically-anisotropic layer) that does not have a refractive index ellipsoid. In a case where the reflective liquid crystal diffraction element is used as the emission element 24, optionally, the emission element 24 may include two cholesteric liquid crystal layers including: a cholesteric liquid crystal layer that has the selective reflection center wavelength corresponding to the first wavelength λ (primary reflected light); and a cholesteric liquid crystal layer that has the selective reflection center wavelength corresponding to the second wavelength λ/2 (secondary reflected light).

In the light guide element according to the embodiment of the present invention, the emission element is not limited to the reflective diffraction element in the example shown in the drawing, and a transmissive diffraction element can also be used. In a case where a transmissive diffraction element is used as the emission element, the emission element is provided on the surface of the light guide plate 18 on the light emission side (user U).

As the transmissive diffraction element, all of well-known diffraction elements can be used. As a preferable example, a transmissive liquid crystal diffraction element described in WO2019/004442A can be used, the transmissive liquid crystal diffraction element having a liquid crystal alignment pattern in which an optical axis derived from a liquid crystal compound continuously changes while rotating in one in-plane direction as shown in FIG. 5 as in the optical element according to the embodiment of the present invention and including a liquid crystal layer (optically-anisotropic layer) where directions of optical axes (molecular axes) of liquid crystal compounds in a thickness direction are the same.

In the light guide element 12 (image display apparatus 10) according to the embodiment of the present invention, as in the incidence element 20, the optical element according to the embodiment of the present invention can also be suitably used as the emission element 24.

In the light guide element 12 of the image display apparatus 10 shown in FIG. 1, the optical element according to the embodiment of the present invention is used as the incidence element 20. However, the light guide element according to the embodiment of the present invention is not limited to this configuration. That is, in the light guide element according to the embodiment of the present invention, the optical element according to the embodiment of the present invention may be used as the emission element.

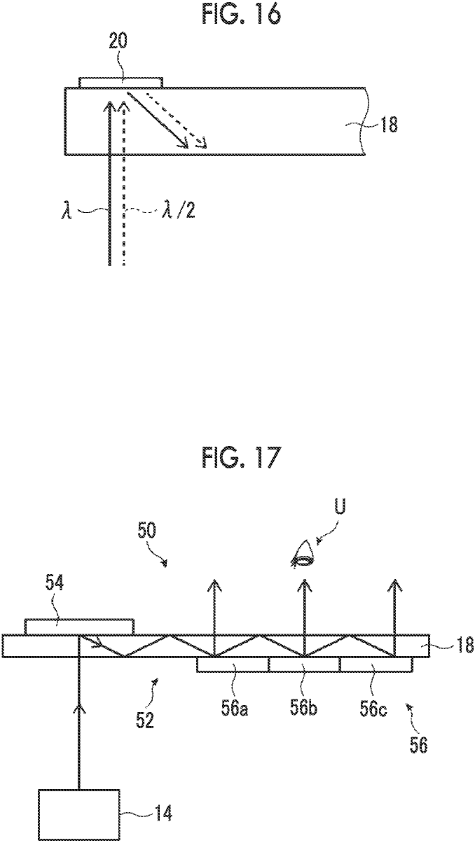

FIG. 17 conceptually shows an example of the image display apparatus including another aspect of the optical element according to the embodiment of the present invention as the emission element. In the image display apparatus 50 shown in FIG. 17, some of the same members as those of the image display apparatus 10 shown in FIG. 1 are used. Therefore, the same members are represented by the same reference numerals, and different members will be mainly described below.

Even in the image display apparatus 50 shown in FIG. 17, light that carries and supports an image displayed by the display 14 is diffracted and reflected by an incidence element 54 as a reflective diffraction element to be incident into the light guide plate 18 at an angle where total reflection can occur.

Here, the image display apparatus 50 shown in FIG. 17 displays only the image in the wavelength range corresponding to the second wavelength λ/2 (secondary reflected light) in the optical element according to the embodiment of the present invention. Accordingly, the display image of the display 14 is an image in the wavelength range (color) corresponding to the second wavelength λ/2.

The incidence element 54 is not limited, and various well-known diffraction elements used as an incidence element in AR glasses or the like can be used.

For example, in the image display apparatus 10 shown in FIG. 1, various diffraction elements used as the examples of the emission element 24 can be used. Accordingly, in the image display apparatus 50 shown in FIG. 17, a transmissive diffraction element may be used as the incidence element. In a case where a transmissive diffraction element is used as the incidence element, the incidence element is disposed on the surface of the light guide plate 18 on the display 14 side.

The light carrying and supporting the image that is caused to be incident into the light guide plate 18 by the incidence element 54 at an angle where total reflection can occur is totally reflected and propagates in the light guide plate 18, and is incident into an emission element 56.

The emission element 56 is the optical element according to the embodiment of the present invention. Accordingly, the emission element 56 includes the cholesteric liquid crystal layer. In addition, the cholesteric liquid crystal layer of the emission element 56 has the liquid crystal alignment pattern in which the optical axis derived from the liquid crystal compound continuously changes while rotating in the one in-plane direction, has the peak of reflection at the first wavelength λ and the second wavelength λ/2, that is, has the refractive index ellipsoid, and has the PG structure where the helical pitch of the cholesteric liquid crystalline phase gradually changes in the thickness direction.

For example, as in the incidence element 20 of the image display apparatus 10 shown in FIG. 1, the emission element 56 in the example shown in the drawing includes the support 30, the alignment film 32, and the cholesteric liquid crystal layer.

As the support 30 and the alignment film 32, those described above can be used. In addition, the cholesteric liquid crystal layer basically has the same configuration as the cholesteric liquid crystal layer 34, except that the distortion of the cholesteric liquid crystalline phase varies depending on regions. This point will be described below.

As described above, the light carrying and supporting the image that is displayed by the display 14 and is incident into and propagates in the light guide plate 18 is the light in the wavelength range corresponding to the second wavelength λ/2.

Accordingly, the light that is totally reflected and propagates in the light guide plate 18 and is incident into the emission element 56 is diffracted and reflected by the emission element 56 as the secondary reflected light (reflected light L₃), and is emitted to the observation position by the user U.

Here, the emission element 56 has three regions including a region 56a, a region 56b, and a region 56c in order from the side close to the incidence element 54. That is, the emission element 56 has the three regions including the region 56a, the region 56b, and the region 56c in order from the upstream side of the light guide plate 18 in a light propagation direction.

In the following description, the upstream side and the downstream side refers to the upstream side and the downstream side of the light guide plate in the light propagation direction.

In the region 56a to the region 56c, the degrees of the changes in the angle between the molecular axes of the liquid crystal compounds 40 in the cholesteric liquid crystal layer having the refractive index ellipsoid are different. That is, in the region 56a to the region 56c, the sizes of the distortion of the cholesteric liquid crystalline phases in the cholesteric liquid crystal layer having the refractive index ellipsoid are different.

Specifically, in the region 56a to the region 56c, the upstream region 56a has the smallest distortion of the cholesteric liquid crystalline phase, the region 56b has a larger distortion of the cholesteric liquid crystalline phase than the upstream region 56a, and the downstream region 56c has the largest distortion of the cholesteric liquid crystalline phase. Accordingly, in the cholesteric liquid crystal layer of the emission element 56, regarding a difference between the average refractive index nx in the slow axis direction and the average refractive index ny in the fast axis direction, the region 56a has the smallest difference, the region 56b has a larger difference than the region 56a, and the region 56c has the largest difference.

By the image display apparatus 50 shown in FIG. 17 having the above-described configuration, the light intensity of the image observed by the user U can be made uniform, and a high-quality image having no unevenness can be displayed.

In the image display apparatus such as AR glasses, in order to display an image having no difference in brightness and having a uniform light intensity, the intensity of light (amount of light) that is diffracted by the emission element and is emitted from the light guide plate needs to be uniform on the entire surface.

Incidentally, in the image display apparatus including the light guide plate, for example, in AR glasses, the intensity of light emitted from the emission element decreases in a direction away from the incidence element.

In the light that propagates in the light guide plate and is incident into the emission element, some percentage of the light is emitted from the upstream portion, and the remaining light arrives at the midstream portion. In the light that is incident into the emission element and arrives at the midstream portion, some percentage of the light is emitted from the midstream portion, and the remaining light arrives at the downstream portion. That is, only the remaining light emitted from the upstream portion and the midstream portion arrives at the downstream portion of the emission element.

Accordingly, in the emission element, the amount of light that arrives at the upstream portion is the largest, the amount of light that arrives at the midstream portion is the second largest, and the amount of light that arrives at the downstream portion is the smallest.

As a result, in the image display apparatus including the light guide plate, there is unevenness in the light amount of the image where the image is bright in the upstream portion of the emission element and the brightness of the image decreases in a direction toward the downstream side.

On the other hand, the image display apparatus 50 in the example shown in the drawing includes the optical element according to the embodiment of the present invention as the emission element 56, in which the image in the wavelength range corresponding to the second wavelength λ/2 is displayed, the upstream region 56a has the smallest distortion of the cholesteric liquid crystalline phase, the region 56b has a larger distortion of the cholesteric liquid crystalline phase than the region 56a, and the downstream region 56c has the largest distortion of the cholesteric liquid crystalline phase.

As described above, in the optical element according to the embodiment of the present invention where the cholesteric liquid crystal layer has the refractive index ellipsoid, as the distortion of the cholesteric liquid crystalline phase increases, the diffraction efficiency (reflected light intensity, reflectivity) of the secondary reflected light corresponding to the second wavelength λ/2 increases.

Accordingly, in the emission element 56, the upstream region 56a has the lowest diffraction efficiency, the midstream region 56b has a higher diffraction efficiency than the upstream region 56a, and the downstream region 56c has the highest diffraction efficiency.

That is, in the region 56a that is the upstream portion where the amount of light arriving is the largest, light is diffracted and reflected with a lower diffraction efficiency than that in the other regions. In the region 56c that is the downstream portion where the amount of light arriving is the smallest, light is diffracted and reflected with the highest diffraction efficiency as compared to the other regions.

As a result, by using the emission element 56 that is the diffraction element according to the embodiment of the present invention, the intensity of light that is diffracted and reflected by the emission element 56 can be made uniform on the entire surface, and a high-quality image having less unevenness in light amount can be displayed.

Here, light is incident into the emission element 56 at various angles. Therefore, in a typical cholesteric liquid crystal layer, a large amount light that cannot be diffracted and reflected is generated by blue shift.

In addition, as described above, in the cholesteric liquid crystal layer having the refractive index ellipsoid, the reflection wavelength range of the secondary reflected light corresponding to the second wavelength λ/2 is narrow, and only the light in a significantly narrow wavelength range can be used.

On the other hand, as described above, in the optical element according to the embodiment of the present invention, the cholesteric liquid crystal layer having the refractive index ellipsoid further has the PG structure where the helical pitch of the cholesteric liquid crystalline phase gradually changes in the thickness direction. Therefore, the reflection wavelength range of the secondary reflected light corresponding to the second wavelength λ/2 is wide.

Thus, by using the emission element 56 that is the optical element according to the embodiment of the present invention, light in a wide wavelength range can be used as the image corresponding to the secondary reflected light (second wavelength λ/2). Further, light incident at various angles can be diffracted and reflected at an angle where the light can be emitted from the light guide plate 18. Therefore, the FOV can be widened.

As described above, the refractive index ellipsoid having distortion in the cholesteric liquid crystalline phase can be formed by irradiating the cholesteric liquid crystalline phase with polarized light before immobilizing the cholesteric liquid crystalline phase.

The cholesteric liquid crystalline phase having the regions where the distortions of the cholesteric liquid crystalline phases are different as in the emission element 56 may be formed, for example, as follows. Before curing the cholesteric liquid crystal layer forming the emission element 56, first, for example, regions of the cholesteric liquid crystal layer other than the region 56a are masked, and polarized light is irradiated. Next, regions of the cholesteric liquid crystal layer other than the region 56b are masked, and polarized light is irradiated in a higher light amount than that in the region 56a. Next, regions of the cholesteric liquid crystal layer other than the region 56c are masked, and polarized light is irradiated in a higher light amount than that in the region 56b.

Next, by curing the cholesteric liquid crystal layer, the cholesteric liquid crystal layer having the refractive index ellipsoid where the distortion of the cholesteric liquid crystalline phase increases in order of the region 56a, the region 56b, and the region 56c can be formed.

In the emission element 56 that is the optical element according to the embodiment of the present invention, the regions where the distortion of the cholesteric liquid crystalline phase changes are not limited to the three regions of the upstream portion/the midstream portion/the downstream portion. That is, the regions where the distortion of the cholesteric liquid crystalline phase changes may be two regions including the upstream portion and the downstream portion or may be divided into four or more regions in the light propagation direction.

In the optical element according to the embodiment of the present invention, various configurations can be used in addition to the incidence element 20 and the emission element 56.

For example, the cholesteric liquid crystal layer in the optical element according to the embodiment of the present invention may be configured to have regions having different lengths of the single periods in the liquid crystal alignment pattern in a plane.

Here, as described above, in the cholesteric liquid crystal layer having the liquid crystal alignment pattern, the reflection angle of light from the equiphase surface E of the cholesteric liquid crystal layer varies depending on the length A of the single period of the liquid crystal alignment pattern over which the optical axis 40A rotates by 180°. Specifically, as the length of the single period A decreases, the angle (diffraction angle θ) of reflected light with respect to specular reflection of incidence light increases. Accordingly, with the configuration in which the cholesteric liquid crystal layer has regions having different lengths of the single periods in the liquid crystal alignment pattern in a plane, the optical element can diffract the primary reflected light and the secondary reflected light at different diffraction angles depending on the in-plane regions.

Optionally, the optical element according to the embodiment of the present invention includes two or more cholesteric liquid crystal layers.

In a case where the optical element includes two or more cholesteric liquid crystal layers, helical pitches of cholesteric liquid crystalline phases of the cholesteric liquid crystal layers can be set to be different from each other such that selective reflection wavelengths are different from each other.

That is, with the configuration in which the optical element includes two or more cholesteric liquid crystal layers having different selective reflection wavelengths, for example, the image display apparatus 10 can selectively display an image of light components (four or more colors) having four or more different central wavelengths.

In addition, in a case where the optical element includes two or more cholesteric liquid crystal layers, the helical turning directions of the cholesteric liquid crystalline phases may be different from each other.

As a result, in the primary reflected light corresponding to the first wavelength λ, both of right circularly polarized light and left circularly polarized light can be reflected.

In addition, in a case where the optical element includes two or more cholesteric liquid crystal layers, the lengths A of the single periods of the liquid crystal alignment patterns of the cholesteric liquid crystal layers may be different from each other.

For example, with the configuration including two or more cholesteric liquid crystal layers in which the selective reflection wavelengths are the same and the lengths of the single periods of the liquid crystal alignment patterns are different from each other, the primary reflected light corresponding to the first wavelength λ and the secondary reflected light corresponding to the second wavelength λ/2 can be reflected in a plurality of different directions (angles).

In addition, in a case where the optical element includes two or more cholesteric liquid crystal layers, the selective reflection wavelengths of the cholesteric liquid crystal layers may be different from each other, and the lengths of the single periods of the liquid crystal alignment patterns may be different from each other.

With the above-described configuration, the light components having a plurality of different central wavelengths including the primary reflected light corresponding to the first wavelength λ and the secondary reflected light corresponding to the second wavelength λ/2 can be reflected in different directions.

Hereinabove, the optical element and the light guide element according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### Formation of Alignment Film

A glass substrate was used as the support.

The following coating liquid for forming an alignment film was applied to the support using a spin coater at 2500 rpm for 30 seconds. The support on which the coating film of the coating liquid for forming an alignment film was formed was dried using a hot plate at 60° C. for 60 seconds. As a result, an alignment film was formed.

Coating Liquid for forming Alignment Film

| | |
|---|---|
| The following material for photo-alignment | 1.00 part by mass |
| Water | 16.00 parts by mass |
| Butoxyethanol | 42.00 parts by mass |
| Propylene glycol monomethyl ether | 42.00 parts by mass |

-Material for Photo-Alignment-

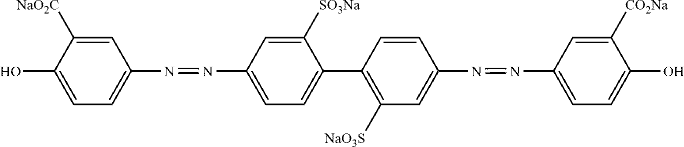

### Exposure of Alignment Film

The alignment film was exposed using the exposure device shown in FIG. 6 to form an alignment film P-1 having an alignment pattern.

In the exposure device, a laser that emits laser light having a wavelength (325 nm) was used as the laser. The exposure amount of the interference light was 300 mJ/cm². An intersecting angle (intersecting angle α) between the two laser beams was adjusted such that the single period A (the length over which the optical axis rotates by 180°) of an alignment pattern formed by interference of the two laser beams was 0.87 µm.

### Formation of Cholesteric Liquid Crystal Layer

As the liquid crystal composition forming the cholesteric liquid crystal layer, the following liquid crystal composition LC-1 was prepared. LC-1- was synthesized using a method described in EP1388538A1, page 21.

Liquid Crystal Composition LC-1

| | |
|---|---|
| Liquid crystal compound L-1 | 100.00 parts by mass |
| Photopolymerization initiator (LC-1-1) | 3.5 parts by mass |
| Photosensitizer (KAYACURE DETX-S, manufactured by Nippon Kayaku Co., Ltd.) | 1.00 part by mass |
| Chiral agent Ch-3 | 2.0 parts by mass |
| Methyl ethyl ketone | 330.60 parts by mass |

Liquid Crystal Compound L-1

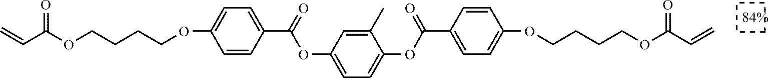

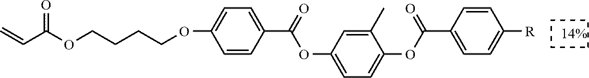

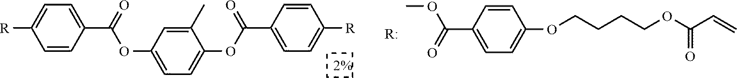

Photopolymerization initiator (LC-1-1)

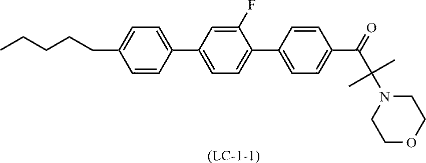

Chiral Agent Ch-3

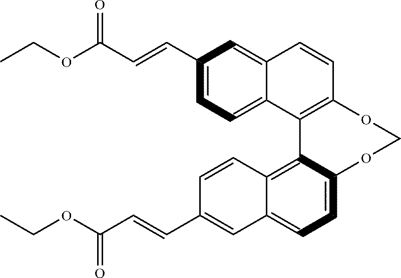

The phase transition temperature of the liquid crystal compound L-1 was obtained by heating the liquid crystal compound on a hot plate and observing the texture with a polarization microscope. As a result, the crystal-nematic phase transition temperature was 79° C., and the nematic-isotropic phase transition temperature was 144° C.

In addition, Δn of the liquid crystal compound L-1 was measured by pouring the liquid crystal compound into a wedge cell, emitting laser light having a wavelength of 550 nm, and measuring the refraction angle of the transmitted light. The measurement temperature was 60° C. Δn of the liquid crystal compound L-1 was 0.16.

The above-described liquid crystal composition LC-1 was applied to the alignment film P-1 using a spin coater at 800 rpm for 10 seconds.

The coating film of the liquid crystal composition LC-1 was heated on a hot plate at 80° C. for 3 minutes (180 sec).

Next, in a first exposure step, the liquid crystal composition LC-1 was exposed using a high-pressure mercury lamp at 100° C. through a long pass filter of 300 nm and a short pass filter of 350 nm. The first exposure step was performed such that the light irradiation dose measured at a wavelength of 315 nm was 30 mJ/cm².

Next, the liquid crystal composition LC-1 was irradiated with polarized UV by using, as a ultraviolet (UV) light source, a polarized UV irradiation device including a combination of a microwave-powered ultraviolet irradiation device (Light Hammer 10, 240 W/cm, Fusion UV systems GmbH) on which D-bulb having a strong emission spectrum in 350 to 400 nm was mounted and a wire grid polarization filter (ProFlux PPL02 (high transmittance type), manufactured by Moxtek, Inc.) (second exposure step). As a result, the cholesteric liquid crystalline phase was immobilized, and a liquid crystal diffraction element including the cholesteric liquid crystal layer was prepared.

The wire grid polarization filter was disposed at a position 10 cm distant from the emission surface.

The irradiation of the polarized UV was performed at an illuminance of 200 mW/cm² and an irradiation dose of 600 mJ/cm² in a nitrogen atmosphere where the oxygen concentration was 0.3% or less.

In addition, the polarized UV was irradiated such that a transmission axis of a polarizing plate was parallel to a direction in which an exposure direction of the alignment film was projected to a plane, that is, an alignment periodic direction in a plane of the cholesteric liquid crystal layer.

### Evaluation of Liquid Crystal Diffraction Element

In a case where the diffraction efficiency of the prepared liquid crystal diffraction element (cholesteric liquid crystal layer) was measured, a diffraction region of reflection having a central wavelength of 1100 nm and having a width of about 400 nm was verified. The reason for this is presumed to be that, since the HTP of the chiral agent was distributed with a deviation in the thickness direction in the first exposure step, a distribution (PG structure) was generated in the helical pitch of the cholesteric liquid crystalline phase in the thickness direction, and primary reflected light (primary reflected and diffracted light) had a distribution in wavelength.

Further, a diffraction region of reflection having a central wavelength of 500 nm and having a width of about 200 nm was verified. The reason for this is presumed to be as follows. In the second exposure step, the twist of the liquid crystal compound in the cholesteric liquid crystalline phase had a deviation in the plane direction (in-plane direction) (the alignment distribution increased depending on the polarization direction of the polarized light exposure). As a result, the secondary reflected light (secondary reflected and diffracted light) was generated at a wavelength that was half of the primary reflected light. In addition, the diffraction angles of the primary reflected light and the secondary reflected light were substantially the same. The reason for this is presumed to be that the configuration where the wavelength is halved and the configuration where the angle is doubled by the secondary diffraction were canceled out such that the angle was the same.

### Application to AR Glasses

By using the liquid crystal diffraction element including the cholesteric liquid crystal layer according to Examples 1 as an incidence element for incidence into a light guide plate of AR glasses and an emission element for emission to the light guide plate of the AR glasses, the effect of the display on the AR glasses shown in FIG. 1 was verified.

As the light guide plate, glass (refractive index: 1.7, thickness: 0.50 mm) was used.

The cholesteric liquid crystal layer according to Example 1 reflects red, green, and red light components as secondary reflected light. This cholesteric layer was laminated on and bonded to the light guide plate to obtain an optical element (diffraction element).

In addition, as a display of the AR glasses, a LCOS type projector was used.

This way, the effect of the display on the AR glasses was verified. As a result, it was verified that the colors of RGB can be displayed.

As can be seen from the above results, the effects of the present invention are obvious.

Explanation of References

| | |
|---|---|
| 10, 50: | image display apparatus |
| 12, 52: | light guide element |
| 14: | display |
| 18: | light guide plate |
| 20, 54: | incidence element |
| 24, 56: | emission element |
| 56a, 56b, 56c: | region |
| 30: | support |
| 32: | alignment film |
| 34, 100: | cholesteric liquid crystal layer |
| 40, 102: | liquid crystal compound |
| 40A: | optical axes |
| 42: | bright portions |
| 44: | dark portions |
| 60: | exposure device |
| 62: | laser |
| 64: | light source |
| 65: | λ/2 plate |
| 68: | polarization beam splitter |
| 70A, 70B: | mirror |
| 72A, 72B: | λ/4 plate |
| R_{R}: | right circularly polarized light of red light |
| M: | laser light |
| MA, MB: | beam |
| P_{O}: | linearly polarized light |
| P_{R}: | right circularly polarized light |
| P_{L}: | left circularly polarized light |
| Q: | absolute phase |
| E: | equiphase surface |
| L₁: | incidence light |
| L₂, L₃, L₄, L_{5:} | reflected light |
| A: | single period |
| X1: | one in-plane direction |
| C1 ~ C7: | liquid crystal compound |
| θ₁ ~ θ₆: | angle |

What is claimed is:

1. An optical element comprising:
a cholesteric liquid crystal layer obtained by cholesteric alignment of a liquid crystal compound,
wherein the cholesteric liquid crystal layer has a liquid crystal alignment pattern in which a direction of an optical axis derived from the liquid crystal compound changes while continuously rotating in at least one in-plane direction,
a helical pitch of a helical axis direction in the cholesteric alignment gradually changes in a thickness direction of the cholesteric liquid crystal layer, and
the cholesteric liquid crystal layer has a peak of reflection at each of a first wavelength λ and a second wavelength λ/2.

2. The optical element according to claim 1,
wherein the cholesteric liquid crystal layer has regions where diffraction efficiencies of light having the second wavelength λ/2 are different in a plane.

3. A light guide element comprising:
the optical element according to claim 1; and
a light guide plate.

4. The light guide element according to claim 3,
wherein the optical element is an incidence element that causes light having the first wavelength λ and light having the second wavelength λ/2 to be incident to the light guide plate at an angle where the light is totally reflected.

5. The light guide element according to claim 3, further comprising:
an incidence element that causes light to be incident to the light guide plate; and
an emission element that emits light from the light guide plate,
wherein the optical element is an emission element that causes light having the second wavelength λ/2 to be emitted from the light guide plate, and
the cholesteric liquid crystal layer has regions where diffraction efficiencies of the light having the second wavelength λ/2 are different in a plane.

6. The light guide element according to claim 5,
wherein in the cholesteric liquid crystal layer, a diffraction efficiency of light having the second wavelength λ/2 gradually increases in a direction away from the incidence element.

7. The light guide element according to claim 5,
wherein the regions where diffraction efficiencies of the light having the second wavelength λ/2 are different in a plane have the lowest diffraction efficiencies of the light having the second wavelength λ/2 in a region on an incident element side, and the highest diffraction efficiency of the light having the second wavelength λ/2 in a region on the opposite to the incident element side.
